(19) United States
(12) Patent Application Publication
(10) Pub. No.: US 2015/0242794 A1
(43) Pub. Date: Aug. 27, 2015

(54) COMPUTER SYSTEMS AND METHODS FOR COMPUTING INCENTIVE COMPENSATION FOR MANAGERS OF INVESTMENT FUNDS

(71) Applicant: Optcapital, LLC, Charlotte, NC (US)

(72) Inventors: Richard D. Ehrhart, Charlotte, NC (US); Mehmet Can Civi, Charlotte, NC (US)

(21) Appl. No.: 14/627,033

(22) Filed: Feb. 20, 2015

Related U.S. Application Data
(60) Provisional application No. 61/943,000, filed on Feb. 21, 2014.
(60) Provisional application No. 62/039,645, filed on Aug. 20, 2014.

(51) Int. Cl. G06Q 10/06

(52) U.S. Cl. CPC G06Q 10/06398; G06Q 40/06

(57) ABSTRACT

Computer systems and methods compute the value of an investment manager's incentive compensation. The investment fund that the manager provides management services to issues shares of service recipient stock comprising common class shares and restricted class shares. The common class shares participate fully in profits and losses, after expenses, of the investment fund, but the restricted class shares do not participate in profits and losses of the investment fund. The fund also issues fund alignment rights to the manager as the incentive compensation. At the close of a valuation period, a host computer system computes (i) the share NAV for the common class shares, (ii) the share NAV for the restricted class shares, (iii) the spread for the fund alignment rights, and (iv) the value of the fund alignment rights. A web server of the host computer system hosts a webpage, accessible to the investment fund via an electronic communication network that posts the computed values.

### PRIORITY CLAIM

The present application claims priority to both of the following United States provisional patent applications: (i) Ser. No. 61/943,000, filed Feb. 21, 2014; and (ii) Serial No. 62/039,645, filed Aug. 20, 2014. Both of these provisional applications are incorporated herein by references in their entirety.

### FIELD OF THE INVENTION

Embodiments of the present invention relate to computer systems and methods for computing incentive compensation for managers of investment funds.

### BACKGROUND

A. Investment Funds that Pay Incentive Compensation

An investment company as any issuer of securities which “is or holds itself out as being engaged primarily or proposes to engage primarily in the business of investing, reinvesting or trading in securities.” Section 3(a)(1) of the Investment Company Act of 1940 (the “40 Act”). An investment company is also called an “investment fund” or “fund.” A fund is a legal entity, and can take the form of a limited partnership, limited liability company or corporation. Funds can be organized in the United States or a foreign country. Funds organized in the United States are commonly organized as partnerships for federal income tax purposes. The fund's income and expenses pass through to the fund's equity owners. Funds organized in other countries are commonly organized as corporations and are not “pass-through” entities.

A fund contracts with an investment adviser to provide the fund with investment advisory and fund management services (herein referred to as the “manager”). Funds provide two types of compensation to managers—management fees and incentive compensation (also called “performance compensation”). Management fees are based on the fund's assets under management (′AUM″). Incentive compensation consists of a share of the investment company's profits.

Current regulations permit four types of investment companies to pay incentive compensation: hedge funds, private equity funds, private long only funds and closed-end 40 Act funds. Open-end 40 Act funds (commonly called “mutual funds”) may not provide incentive compensation.

Section 7(a)(1) of the 40 Act generally prohibits an investment company from engaging in the business of buying and selling securities unless it has registered with the Securities and Exchange Commission (SEC) or has a valid exemption from registration.

A private investment company is one that is exempt from the 40 Act's registration requirements under either section 3(c)(1) or section 3(c)(7). Section 3(c)(1) excepts from the definition of investment company a fund that meets two requirements: (i) not more than 100 investors and (ii) is not making and has no plans to make a public offering. Section 3(c)(7) provides an exemption for funds whose investors are qualified purchasers and which is not making and has no plans to make a public offering. A section 3(c)(7) fund could, in theory, have an unlimited number of investors. There is another regulation, however, that imposes a practical numerical limit on the number of investors. Section 12(g) of the Securities Exchange Act of 1934 (the “Exchange Act”) requires domestic issuers of securities, with total assets exceeding $10 million, and a class of equity securities held by 500 or more persons, to register under the Exchange Act absent an exemption.

Generally, private investment companies employ one of three types of investment strategies: (i) generating positive absolute returns by investing long and short (commonly called “hedge” investing) funds, (ii) generating positive relative returns by investing long only, and (iii) investing in private equity.

Hedge funds invest in financial markets on behalf of wealthy individuals and institutions, often utilizing some combination of non-traditional portfolio management strategies, such as short sales and leveraged long positions. Hedge funds in general attempt to earn absolute returns as opposed to relative returns, meaning that positive returns are sought in both declining and rising securities markets, rather than performance being measured against market benchmarks. Many hedge funds are highly leveraged, which allows them to compound the benefits of the successful benefits they make. This works both ways though; leverage also magnifies losses. For example, if a fund makes an investment with a debt-to-equity ratio of two-to-one, meaning that $2 of borrowed money is invested for every $1 of equity invested, the effects of changes in value of the investment will be magnified three times, as compared to an all-equity investment. In this scenario, if the underlying assets increase in value by 20%, the fund gains 60% on the capital it has invested, triple what it would gain if no borrowed funds had been used. Conversely, if the assets fall in value 20%, the fund's loss on the investment is tripled. According to most industry estimates, the average leverage ratio of hedge funds is between two-to-one and three-to-one. Generally, such funds are open-end with no fixed duration. An “open-end” fund is one without restrictions on the number of shares it will issue. The fund maintains an investment management agreement with an investment adviser. The investment adviser, or “manager,” executes the fund's investment management strategy.

Private long only funds invest in financial markets on behalf of wealthy individuals and institutions utilizing the traditional portfolio management strategy of buying low and selling high. Such funds in general seek to earn superior relative returns, meaning that positive relative returns are sought against a specified market benchmark or index. Generally, private long only funds do not utilize leverage, although there are exceptions. Although such funds are open-end with no fixed duration, in practice such funds tend to be “funds of one,” meaning that they have one investor. The find maintains an investment management agreement with an investment adviser. The investment adviser, or “manager,” executes the fund's investment management strategy.

Private equity funds invest in securities that are not actively traded on an established market on behalf of wealthy individuals and institutions. Typically, funds have durations of 10 years, subject to one-year extensions. An investor makes an unfunded capital commitment to the fund, and the fund calls on the commitment over an initial investment period during which the fund invests in various deals. From the investor's point of view, the fund can be traditional where all the investors invest with equal terms or asymmetric where different investors have different terms. An investment adviser is responsible for securing capital contribution commitments from investors and executing the fund's investment strategy (the “manager”). A private equity fund typically makes investments in companies (known as portfolio companies). These portfolio company investments, or “deals,” are funded with the capital raised from investors, and may be partially or substantially financed by debt. Some private equity investment transactions can be highly leveraged with debt financing—hence the acronym LBO for “leveraged buy-out”. The cash flow from the portfolio company usually provides the source for the repayment of such debt. Such LBO financing most often comes from commercial banks, although other financial institutions, such as hedge funds and mezzanine funds, may also provide financing. Since mid-2007, debt financing has become much more difficult to obtain for private equity funds than in previous years. LBO funds commonly acquire most of the equity interests or assets of the portfolio company through a newly-created special purpose acquisition subsidiary controlled by the fund, and sometimes as a consortium of several like-minded funds.

Generally, hedge funds and private long only funds have no pre-determined duration or limit on number of investments, and investors can contribute and redeem at specified liquidity dates, such as at the end of each month or quarter. Institutional investors, such as public and private pensions, foundations and endowments, tend to invest with such a fund for several years. Private equity funds, on the other hand, are of limited duration. Typically, investors make a commitment to contribute a specified amount over a specified period of time. Once the capital commitments are made, the fund closes to new investors. The fund invests the capital in a finite number of deals. Normally, the fund does not reinvest proceeds realized from a deal, but distributes the proceeds to investors and the manager. As described below, the amount and timing of the profit distributions to the manager depends on whether the fund follows the American Method or the European Method.

Closed-end 40 Act funds are registered with the SEC under the 40 Act. Because they are registered, they have no limit to their number of investors. They are “closed-end” in the sense that they invest exclusively on behalf of wealthy individuals and institutions that qualify as “accredited investors.” Generally, closed-end 40 Act funds execute hedge fund-type investment management strategies. By contrast, a registered open-end fund, or mutual fund, is not limited to investors who are accredited investors or “qualified purchasers.” Open-end mutual funds provide daily liquidity, while closed-end funds need not. Open-end mutual funds are taxed as regulated investment companies (“RICs”) under Subchapter M of the Internal Revenue Code. In general a RIC does incur corporate income tax provided that it annually distributes ordinary dividends and capital gains sufficient to shareholders sufficient to offset taxable income and net capital gains. Closed-end funds have the option to elect RIC status.

Generally, funds can be organized as corporations, limited partnerships or limited liability companies. Investors receive either shares of stock (in the case of a corporation), limited partnership interests (in the case of a limited partnership), or membership interests (in the case of a limited liability company). Regardless of the form, the investors' units of ownership interests represent a fractional undivided interest in the fund's equity, or net asset value (NAV). For purposes hereof, each unit of equity ownership that participates in the fund's profits and losses is called a “share,” “common share,” or “participating share.” The price of each share is sometimes called the “share NAV.”

### B. Current Incentive Compensation

1. In General

The incentive or performance-based element of compensation is intended to reward the manager for successfully generating positive returns (profits) on the fund's investment portfolio.

Section 205(a)(1) of the Investment Advisers Act of 1940 (the “Advisers Act”) contains a general prohibition against performance-based or incentive compensation that applies to all investment advisers registered or requested to be registered with the SEC. Registered advisers, however, may still earn incentive compensation if they can meet an exception to this prohibition contained in Rule 205-3 under the Advisers Act. This rule provides relief to advisers by permitting them to charge performance-based compensation to “qualified clients.” A qualified client must
1) have a net worth of at least $2 million,
2) have at least $1 million under management by the adviser,
3) be a “qualified purchaser” under section 2(a)(51)(A) of the 40 Act, or
4) fall within certain categories of knowledgeable employees of the adviser.

In general, an open-end mutual fund cannot charge incentive compensation. A closed-end 40 Act fund may charge performance fees provided all investors have a net worth of at least $2 million and at least $1 million under management with the adviser (manager).

In general, private funds may charge incentive compensation for both accredited investors and qualified purchasers.

2. Incentive Compensation Paid by Hedge Funds

The basis for calculating profits for hedge fund incentive compensation is realized and unrealized profits (losses), net of the management fee, for a specified period. Typically, the period is the calendar year, but some funds determine or crystallize the incentive compensation each calendar quarter or month.

Most hedge funds pay incentive compensation with respect to new profits or new growth only. This requires the manager to make up for prior period losses before becoming entitled to current period incentive compensation allocation. Normally, the fund tracks, with respect to each investment, the investment's “high water mark.” For example, suppose an investor invests $100,000 in a hedge fund that pays a 20% performance fee that is crystallized annually. After the first year, the investment incurs a $18,000 loss and is worth $80,000 after $2,000 of management fees. Assume that after the second year the investment gains $32,000 and is worth $110,000 after management fees. The manager would be entitled to a performance fee with respect to only the $10,000 of profit, the $30,000 of profit in excess of the $100,000 high water mark.

3. Incentive Compensation Paid by Private Equity Funds

The basis for calculating profits for private equity manager incentive compensation is realized profits. Normally, the manager shares in profits in excess of a specified hurdle rate of return. In such case, it is common to provide a “catch up” allocation for the manager. For example, the manager may receive 20% of profits in excess of an 8% return on investor capital, subject to a catch up whereby the manager receives 100% of the profits for the return between 8% and 10%. Stated another way, the manager is entitled to 20% of the profits, subject to a hierarchy or “waterfall” where the investor receives all the profits up to the hurdle rate, the manager receives all of the remaining profits up to an amount that divides the profits 80/20 (i.e., profits up to an amount equal to 25% of the profits allocated to the investor under the hurdle rate allocation (20%/80%=25%)).

Private equity funds use either the American Method or the European Method. Under the American Method, the manager's share of profits is crystallized with respect to, and upon, each realization of profits from an investment or deal. Under the European Method, the manager's share of profits is crystallized with respect to, and upon, the realization of the cumulative profits by the fund across all the fund's investments or deals. Even under the European Method, however, the manager receives an agreed upon percentage of the realized profits with respect to, and upon, each realization of profits from a deal. This distribution is intended to reimburse the manager for taxes owed on the manager's share of the profits. Normally such percentage is 40%.

To illustrate the American Method, assume the fund makes two investments, and in year 2 realizes a profit on one deal of $2 million and in year 3 realizes a loss of $2 million in year 4 on the other deal. The fund would pay the manager $400,000 with respect to the year 2 profit realization, even though the fund's cumulative profit is zero.

To illustrate the European Method, assume the same facts as in the preceding paragraph. The fund would pay the manager 40% of $400,000 after the year 2 realization, or $160,000, even though the fund's cumulative profit is zero.

Some funds require the manager to repay incentive compensation paid in excess of the amount that would have been paid had profits been calculated on a cumulative basis across all investments, less amounts the manager owes for income taxes with respect to its share of the profits. This is commonly called a “claw back.”

Under the current method of incentive compensation, a private equity fund liquidates upon the earlier of the realization of all deals, or a specified period to time. If an investor reinvests proceeds from a fund into another fund advised by the manager, the process for calculating profits and incentive compensation starts over. There is no carryover of profits or losses from previous investments with the manager.

4. Incentive Compensation Paid by Private Long Only Funds

It is rare for private long only funds to pay managers incentive compensation. Normally, compensation consists of a management fee based on assets under management.

When private long only funds provide incentive compensation, the fund normally pays a percentage of profits each year to the extent the profits exceed an index. For example, the fund may provide the manager with 50% of the profits to the extent the return exceeds the S&P 500 Total Return Index.

5. Incentive Compensation Paid by Closed-End 40 Act Funds

Under the prevailing method, a closed-end 40 Act fund pays incentive compensation monthly annually based on a rolling 3-year average return. The incentive compensation is an adjustment to the base management fee.

For example, assume a fund with an absolute return target of outperforming the S&P 500 Total Return Index and T-bill returns. Assume also that the base fee is 1.5% of AUM, and the incentive compensation is 5% of the overperformance or underperformance. Assume the fund's return over T-bills is 8%, and the fund's return over the S&P 500 Total Return Index is 5%. The base fee would increase by 0.25% to 1.75% (5% times the overperformance of 5%).

By way of further example, assume that the fund described in the preceding paragraph realized a negative 4% return when the T-bill rate was 2% and the S&P 500 Total Return Index was −6%. The underperformance would be 6%, and the base fee would be reduced by 0.30% to 1.20%.

6. Incentive Compensation for Manager Employees

Typically, a manager is an entity and not a natural person. The manager employs traders, portfolio managers, analysts, executives, salespersons and others. A manager is ordinarily formed as a limited liability company, but may be a general partnership, limited partnership or corporation. It is common for managers to be closely held, with equity ownership and management coinciding. There are, however, publicly traded managers. For purposes hereof, the manager is an immediate service provider to the fund, the manager's employees are immediate service providers to the manager and ultimate service providers to the fund. Conversely, the fund is the immediate service recipient of the manager and the ultimate service recipient of the manager's employees. For purposed hereof, a service provider to the manager is referred to as an “employee,” regardless of whether the service provider provides such services in the capacity of an employee, partner or independent contractor.

Under the current method of incentive compensation, managers pay their key employees a share of the incentive compensation the manager receives from the fund. Because the manager's incentive compensation is crystallized each year, the practice is for the manager to pay incentive compensation to its key employees each year as well. Consequently, it is uncommon for managers to defer incentive compensation to the end of multi-year periods to create longer term incentives for such key employees to maximize profits over the life of multi-year investments.

### C. Current FMV Option/SAR Method and Applications

1. In General

For a compensatory option or stock appreciation (SAR) to qualify, it must satisfy certain requirements:
First, the option/SAR is granted with respect to “service recipient stock.”
Second, the option/SAR is granted by an “eligible issuer of service recipient stock.”
Third, the compensation payable upon exercise of the option/SAR is not greater than the excess of the fair market value of the of the underlying stock on the date the options/SARs are exercised over the fair market value of the underlying stock on the date the option/SAR was granted, and the number of shares of underlying stock is fixed on the issuance date.
Fourth, the strike price for the option/SAR is never less than the fair market value of the underlying stock on the date the option/SAR was granted.
Fifth, the option/SAR does not include any other feature for the deferral of compensation.

An option is the right to purchase specified stock of the fund at a specified price, or “strike price.” The benefit of an option is the excess, if any, of the value of the specified stock at the time of exercise over the strike price at the time of exercise. Such excess is called the “spread.” For purposes hereof, the specified stock that is subject to an option is referred to as “underlying shares” or “underlying stock.”

A SAR is economically identical to an option. Instead of conferring a right to purchase underlying shares, though, a SAR gives the holder the right to receive the spread upon exercise. The SAR agreement will specify whether the spread is payable in cash or underlying stock.

In general, “service recipient stock” means “common stock.” Common stock is any stock that is not preferred stock. Preferred stock is stock which, in relation to other classes of stock outstanding, enjoys certain limited rights and privileges (generally associated with specified dividend and liquidation priorities) but does not participate in corporate growth to any significant extent.

Service recipient stock does not include a class of stock that has any preference as to distributions other than distributions of service recipient stock and distributions in liquidations of the issuer. Service recipient stock also cannot be subject to a mandatory repurchase obligation (other than a right of first refusal) or subject to a put or call right that is not a lapse restriction if the stock price under such right or obligation is based on a measure other than fair market value.

The requirement that the option/SAR be granted by an “eligible issuer of service recipient stock” means that the stock options must be granted by the entity for which the service provider provides services or another entity higher in the chain in the same controlled group of entities.

There is a difference in which investment companies' stock and non-investment companies' stock is valued. Investment company stock value is the aggregate of its investments less indebtedness (“net asset value” or “NAV”). Its market value and book value are the same. The equity or stock value of a non-investment company is usually higher than the sum of its net assets.

When an investment company issues options/SARs to provide a specified percentage of profit, the company's stock is diluted and the price of a share is reduced. For example, suppose an investment company has a fund NAV of $100 million. If it has 10,000,000 shares of common stock outstanding, the NAV per share would be $10. If the company were to issue options/SARs providing 20% of the company's profits, it would issue options/SARs on 2,500,000 of underlying shares (2,500,000 underlying shares divided by 12,500,000 total shares=20%). Upon issuance of options/SARs, the NAV per share would decrease from $10.00 to $8.00 ($100,000,000 divided by 12,500,000 shares).

Because the value of the equity stock of a non-investment company is independent of the book value per share, the granting of options/SARs does not necessarily reduce the price per share.

Options/SARs are issued with respect to contributions or investments made to the fund. For purposes hereof, (i) such options/SARs are called “contribution option/SARs,” and (ii) the shares issued to the investor and contribution options/SARs are deemed to be “related” to each other.

If the parties so agree, the fund can also issue options/SARs periodically with respect to new growth or new profits. For purposes hereof, such “new growth options/SARs” are related to the contributions or investments that produced the growth or profit, and thus related to the shares issued with respect to such contribution or investment.

When an investor redeems shares, the related options/SARs become unsupported or “orphaned.” The investor receives back its contribution, reduced by any losses and increased by any profits less the manager's option/SAR spread. The spread equals the value of the underlying shares less the strike price. Consequently, upon a redemption the fund no longer has the capital equal to the spread of the related options/SARs, but does not have the capital corresponding to the strike price of the related options/SARs.

After an investor's redemption, a manager may wish to continue the life of orphaned options/SARs. The remaining investors will insist that such continuation not dilute their investment. To avoid dilution, the fund must have capital sufficient to support the strike price of the orphaned options/SARs. There are two ways to continue options/SARs beyond the redemption of share related to the orphaned options/SARs—financing and reassignment.

Financing involves borrowing the capital needed to support orphaned options/SARs. To ensure that the manager, and not the other investors, bears the cost of the borrowing, the strike price of the orphaned options/SARs would increase at a rate at rate no less than the interest rate on the loan.

Or, the manager may prefer to re-assign the orphaned options/SARs to remaining outstanding shares as a replacement for the options/SARs that are related to such shares. Reassignment of orphaned options/SARs can follow any of a number of different protocols. Typically, the orphaned options/SARs would be reassigned to replace options/SARs of lower value. Options/SARs with the lowest value would be replaced first, then the ones of next lowest value, and so forth until all the orphaned options/SARs are reassigned, or not reassigned because the remaining assigned options/SARs are of equal or greater value than the orphaned options/SARs. This process is called “optimization.”

For purposes hereof, (i) an investor's transfer of cash to a fund in exchange for shares is a “contribution” or an “investment,” (ii) the event of a manager acquiring a legally binding right to FMV options/SARs from a fund is an “issuance,” “grant” or “award,” and (iii) a person includes a natural person or an entity.

2. Hedge Fund Applications

Hedge fund use of FMV options/SARs is rare, and applicant knows of only one fund that provides incentive compensation in the form of FMV options/SARs.

Under the current method by which a hedge fund provides incentive compensation in the form of FMV options or FMV SARs, the fund issues the option or SAR with respect to authorized but not issued shares. As a result, the strike price at issuance is less than the fair market value of the shares immediately before the issuance. For example, assume the investor invests $100 and receives 100 shares with a per share price of $1.00. Assume also that the investor agrees that the adviser will receive options providing 20% of the profits. Under the current method, the fund would issue an option to purchase 25 authorized but unissued shares, or 20% of the total 125 shares. The strike price, however, would have to be $0.80 per share, the price per share on a fully diluted basis ($100/125 shares). This method causes a concern of whether the option's strike price is less than the fair market value of the shares at the moment of issuance.

Under the current method by which a hedge fund provides incentive compensation in the form of FMV options or FMV SARs, funds do not vary the option/SAR terms from investment to investment. Under the current method, each option/SAR, and the investment related to such options/SARs, have the same terms with respect to strike price, strike price adjustment rate, earliest exercise date, early or excess exercise fees, earliest redemption date, early or excess redemption fees, and latest exercise date.

Under the current method by which a hedge fund provides incentive compensation in the form of FMV options/SARs, the option/SAR is exercised when the underlying investment is redeemed.

Under the current method by which a hedge fund provides incentive compensation in the form of FMV options/SARs, there is no method by which the manager can share in more than its nominative share of the profits earned on the reinvestment of its share of the profits. In other words, the current method does not provide for new growth FMV options/SARs on interim profits and thereby enable the manager to compound its share of the profits in the same manner that the manager compounds by reinvesting its share of profits under the Annual Crystallization method.

Under the current method by which a hedge fund provides incentive compensation in the form of FMV options/SARs, there is no method that enables the manager to continue the options after the investor's redemption of the shares with respect to which the options/SARs were granted. Upon an investor's redemption of shares, the manager must exercise the related FMV options/SARs.

Under the current method by which a hedge fund provides incentive compensation in the form of FMV options/SARs, there is no method that enables the manager to continue the options after the investor's redemption of the shares with respect to which the options/SARs were granted. Upon an investor's redemption of shares, the manager must exercise the related FMV options/SARs.

Under the current method by which a hedge fund provides incentive compensation in the form of FMV options/SARs, there is no computer system that enables a fund (i) to value options/SARs no less frequently than the frequency with which the fund's shares are valued, (ii) to vary the material terms of, and keep track of the terms of, options/SARs, including the exercisability period, the earliest redemption date, the early or excessive exercise fees, and the early or excessive redemption fees, (iii) to issue options/SARs with a strike price that is not less than the fair market value of the underlying stock immediately before the issuance, (iv) to issue new growth options/SARs and to keep track of the same in the same manner as contribution options/SARs, (v) to keep track of the relationship of options/SARs to outstanding fund shares (i.e., shares and options/SARs related to each other), (vi) upon redemption of shares, or election to redeem shares, to identify the options/SARs related to such redeemed shares and determine the manager's exercise rights and conditions, (vii) upon an exercise of options/SARs, or an election to exercise options/SARs, to identify the shares related to such options/SARs and determine the investor's redemption rights and conditions, (viii) to continue the life of orphaned option/SAR beyond the redemption of related shares, (ix) to finance orphaned options/SARs, (x) to reassign orphaned options/SARs according to a prescribed reassignment process, (xi) to provide investors with online access to their accounts including the details of options/SARs granted with respect to the investor's investment in the fund and the ability to redeem shares online, and (xii) to provide managers with online access to their accounts including the details of their options/SARs and the ability to exercise options/SARs online.

3. Private Equity Funds

Private equity funds do not use FMV options or FMV SARs.

4. Private Long Only Funds

Private long only funds do not use FMV options or FMV SARs.

5. Closed-End 40 Act Funds

Closed-end 40 Act Funds do not use FMV options or FMV SARs.

6. Incentive Compensation for Manager Employees

Because managers are not the beneficiaries of incentive compensation that crystallizes after a multi-year period of performance, the manager's key employees are not the beneficiaries of incentive compensation that crystallizes after a multi-year period of performance.

### D. Need

1. In General

The current methods of incentive compensation for fund managers are short-term and fail to reward managers for maximizing risk-adjusted returns on an investment with a manager that continues for more than one year. Consequently, current methods of fund manager incentive compensation fail to align fund managers with the interests of multi-year investors in maximizing long-term wealth creation.

Clearly, what is needed in the art is a new method of providing such compensation that enables a fund (i) to pay the manager with respect to the cumulative profits on an investor's investment over the life of the investment with the manager, even if such life spans multiple quarters, years, or deals, (ii) to have a perpetual life enabling investors to invest for as long they wish and to receive their share of the cumulative profits with respect to their investment, (iii) to accumulate the manager's share of the profits pre-tax, tax-deferred over the life of an investment, (iv) to value options/SARs no less frequently than the frequency with which the fund's shares are valued, (v) to vary the material terms of, and keep track of the terms of, options/SARs, including the exercisability period, the earliest redemption date, the early or excessive exercise fees, and the early or excessive redemption fees, (vi) to issue options/SARs with a strike price that is not less than the fair market value of the underlying stock immediately before the issuance, (vii) to issue new growth options/SARs and to keep track of the same in the same manner as contribution options/SARs, (viii) to keep track of the relationship of options/SARs to outstanding fund shares (i.e., shares and options/SARs related to each other), (ix) upon redemption of shares, or election to redeem shares, to identify the options/SARs related to such redeemed shares and determine the manager's exercise rights and conditions, (x) upon an exercise of options/SARs, or an election to exercise options/SARs, to identify the shares related to such options/SARs and determine the investor's redemption rights and conditions, (xi) to finance orphaned options/SARs, (xii) to reassign orphaned options/SARs according to a prescribed optimization process, (xiii) to provide investors with online access to their accounts including the details of options/SARs granted with respect to the investor's investment in the fund and the ability to redeem shares online, and (xiv) to provide managers with online access to their accounts including the details of their options/SARs and the ability to exercise options/SARs online.

2. Hedge Funds

The current methods of incentive compensation for hedge fund managers are short-term and fail to reward managers for maximizing risk-adjusted returns on an investment with the manager that continues for more than one year. Consequently, current methods of hedge fund manager incentive compensation fail to align managers with the interests of multi-year investors in maximizing long-term wealth creation.

Under the prevailing method of incentive compensation, the manager's share of profits with respect to a particular contribution from an investor is crystallized each year. As a result, the investor bears all subsequent losses, with the manager bearing none. Equally important, the investor loses its share of the profits that would have been earned on the profits the manager crystallized.

What is needed is a new method by which investors and managers can keep all the fund's assets invested for the life of the investment, and then divide the profits when the investor redeems its shares or otherwise withdraws its interest in the fund. To be feasible, the method needs to defer income taxation on the manager's share of the profits until the manager receives its compensation.

In the one known instance in which a hedge fund has issued FMV options to the manager, the fund used the traditional one class of stock method and simply issued options/SARs on a number of unissued common shares that would produce the desired profit sharing. The problem with that method is that it diluted the common shares and as a result the strike price of the options was less than the fair market value of the underlying shares immediately prior to the issuance of the option.

In addition, under this method the fund has no ability, using a computer system, to vary the terms of options from contribution to contribution, including terms involving exercisability, redeemability of related shares, early or excessive exercise fees, early or excessive redemption fees, or adjustments to the strike price based on an index or interest rate.

In addition, under this method there is no ability for the manager or the investor to view their share and option/SAR data online, or to redeem shares or exercise options/SARs.

In addition, there is no method for allowing the manager to receive FMV options/SARs with respect to profits earned on the reinvestment of the manager's share of profits in excess (in excess of the nominative share). For example, assume an investor contributes $100 and the fund grants the manager an option to purchase common stock shares having a grant date value of $20 for a strike price. Assume the value of the shares doubles after the first year. The option would have a value of underlying shares/strike price/spread (“VUS/SP/Spd”) of $40/$20/$20. Assume that during the second year, the share value doubles again resulting in a VUS/SP/Spd of $80/$20/$60. The increase in the spread from $20 to $60, or $40, is 20% of the year 2 profits of $200. The current method does not enable the manager to earn more than 20% of the profits attributable to the reinvestment of its share of the profits.

In addition, the options/SARs must be exercised when the related shares are redeemed. There is no opportunity for the manager to extend the life of the options/SARs through financing or reassignment to other investors.

What is needed is a new method by of providing such compensation that enables a fund (i) to pay the manager with respect to the cumulative profits on an investor's investment over the life of the investment with the manager, even if such life spans multiple years, (ii) to have a perpetual life enabling investors to invest for as long they wish and to receive their share of the cumulative profits with respect to their investment, (iii) the manager to accumulate its share of the profits pre-tax, tax-deferred over the life of an investment, (iv) to value options/SARs no less frequently than the frequency with which the fund's shares are valued, (v) to vary the material terms of, and keep track of the terms of, options/SARs, including the exercisability period, the earliest redemption date, the early or excessive exercise fees, and the early or excessive redemption fees, (vi) to issue options/SARs with a strike price that is not less than the fair market value of the underlying stock immediately before the issuance, (vii) to issue new growth options/SARs and to keep track of the same in the same manner as contribution options/SARs, (viii) to keep track of the relationship of options/SARs to outstanding fund shares (i.e., shares and options/SARs related to each other), (ix) upon redemption of shares, or election to redeem shares, to identify the options/SARs related to such redeemed shares and determine the manager's exercise rights and conditions, (x) upon an exercise of options/SARs, or an election to exercise options/SARs, to identify the shares related to such options/SARs and determine the investor's redemption rights and conditions, (xi) to finance orphaned options/SARs, (xii) to reassign orphaned options/SARs according to a prescribed optimization process, (xiii) to provide investors with online access to their accounts including the details of options/SARs granted with respect to the investor's investment in the fund and the ability to redeem shares online, and (xiv) to provide managers with online access to their accounts including the details of their options/SARs and the ability to exercise options/SARs online.

3. Private Equity Funds

The current methods of incentive compensation for private equity managers are short-term and fail to reward managers for maximizing risk-adjusted returns on an investment with the manager that continues for more than deal or more than one fund. Consequently, current methods of private equity fund manager incentive compensation fail to align managers with the interests of investors in maximizing wealth creation over the life of an investment with a manager.

Under the prevailing method of incentive compensation, private equity funds are closed-end funds, and have a finite number of investors, a finite amount of contributions, a finite number of deals and a finite life.

In addition, under the prevailing method the manager can crystallize a share of annual profits even if the fund, on a cumulative basis, has no profits.

Under the prevailing private equity model, the fund invests in discrete private equity deals with the objective of selling its investment at a profit (“Deal Realization”). On each Deal Realization, the investors receive back their contributions reduced by fees and expenses and increased by its share of the capital appreciation or reduced by capital depreciation. Investors' share of capital appreciation typically consists of a specified percentage of the profits (for example, 80%), but not less than an amount that would produce a rate of return equal to the hurdle rate. On each Deal Realization, the manager crystallizes its share of the profits. The timing of payment of the manager's share of the profits depends on whether the fund uses the American Method or the European Method.

Under the American Method, the fund pays the manager its share of the profits on each Deal Realization. Typically, the manager is entitled to a specified percentage of profits (for example, 20%), subject, however to a “catch up” share when the profits do not produce a rate of return sufficient to pay the investors the hurdle rate and pay the manager its share of the profits. For example, if the profit sharing was 80/20 and the hurdle rate was 8%, the profit sharing possibilities from a Deal Realization would be as follows:

| Return | Investors | Manager |
|---|---|---|
| Rate of Return less | Receive 100% | Receives 0% |
| than or equal to 8% | of profits | of profits |
| Rate of Return greater | Receive profits | Receives 100% of |
| than 8% but less than | up to 8% return | profits in excess |
| or equal to 10% | | of 8% return |
| Rate of return greater | Receive 80% | Receives 20% |
| than 10% | of profits | of profits |

Under the European Method, the fund pays the manager part of its share of the profits on each Deal Realization, and pays the remainder at the end of the life of the fund after all Deal Realizations. The partial distribution of profits is designed to reimburse the manager for income taxes owed, and is typically 40% of the manager's share of profits. At the end of the fund, the manager receives its share of cumulative profits from all Deal Realizations. The European Method is commonly called a “waterfall payout.” Payouts follow a hierarchy where (i) investors receive amounts up to their contributions, (ii) investors receive amounts up to their hurdle rate of return, (iii) manager receives a catch up distribution, and (iv) investors and manager share divide the remainder in the specified percentages. For example, if the profit sharing was 80/20 and the hurdle rate was 8%, the profit sharing possibilities from all Deal Realizations would be as follows:

| Return | Investors | Manager |
|---|---|---|
| Rate of Return less | Receive 100% | Receives 0% |
| than or equal to 8% | of profits | of profits |
| Rate of Return greater | Receive profits | Receives 100% of |
| than 8% but less than | up to 8% return | profits in excess |
| or equal to 10% | | of 8% return |
| Rate of return greater | Receive 80% | Receives 20% |
| than 10% | of profits | of profits |

Neither the American Method nor the European Method provides cumulative profit sharing across all Deal Realizations. Without true cumulative profit sharing, investors receive less than their nominative share of profits, and the manager receives more. In some cases, the fund seeks to achieve true cumulative profit sharing through agreements requiring the manager to pay back amounts received in excess of its share of cumulative profits. These agreements are commonly called “claw back” agreements.

Claw back agreements are difficult to draft and enforce. Their efficacy is dependent on the cooperation and solvency of the manager.

Neither the American Method nor the European Method enables an investor to enjoy cumulative profit sharing perpetually with respect to each dollar of investment with a manager. Each method requires that the fund have a finite life and a final accounting. At the end of the fund, the manager's final incentive compensation is settled and any claw backs enforced.

When the investor invests in serial private equity funds of the same manager, the investor loses the return it would have made on the incentive compensation the manager received from previous funds. The investor also loses the manager's participation in subsequent losses. In other words, while a fund may provide a claw back, managers do not provide claw backs from fund to fund.

The current model of funds with finite lives requires managers to sponsor serial funds. Investors commit capital to a finite fund, withdraw capital upon each Deal Realization, and the fund is finally liquidated and closed. The manager then sponsors a new fund, secures capital commitments (often from same investors), and starts the life cycle again.

In addition, under the prevailing method the manager is taxable on its share of the annual profits even if the fund, on a cumulative basis, has no profits.

What is needed is a new method by of providing such compensation that enables a fund (i) to pay the manager with respect to the cumulative profits on an investor's investment over the life of the investment with the manager, even if such life spans multiple years or deals, (ii) to have a perpetual life enabling investors to invest for as long they wish and to receive their share of the cumulative profits with respect to their investment, (iii) the manager to accumulate its share of the profits pre-tax, tax-deferred over the life of an investment, (iv) to value options/SARs no less frequently than the frequency with which the fund's shares are valued, (v) to vary the material terms of, and keep track of the terms of, options/SARs, including the exercisability period, the earliest redemption date, the early or excessive exercise fees, and the early or excessive redemption fees, (vi) to issue options/SARs with a strike price that is not less than the fair market value of the underlying stock immediately before the issuance, (vii) to issue new growth options/SARs and to keep track of the same in the same manner as contribution options/SARs, (viii) to keep track of the relationship of options/SARs to outstanding fund shares (i.e., shares and options/SARs related to each other), (ix) upon redemption of shares, or election to redeem shares, to identify the options/SARs related to such redeemed shares and determine the manager's exercise rights and conditions, (x) upon an exercise of options/SARs, or an election to exercise options/SARs, to identify the shares related to such options/SARs and determine the investor's redemption rights and conditions, (xi) to finance orphaned options/SARs, (xii) to reassign orphaned options/SARs according to a prescribed optimization process, (xiii) to provide investors with online access to their accounts including the details of options/SARs granted with respect to the investor's investment in the fund and the ability to redeem shares online, and (xiv) to provide managers with online access to their accounts including the details of their options/SARs and the ability to exercise options/SARs online.

4. Private Long Only Funds

The current methods of incentive compensation for private long only fund managers are short-term and fail to reward managers for maximizing risk-adjusted returns on an investment with the manager that continues for more than one year. Consequently, current methods of private long only fund manager incentive compensation fail to align managers with the interests of multi-year investors in maximizing long-term wealth creation.

Under the prevailing method of incentive compensation provided by private long only funds, the manager's base management fee is increased by a specified percentage of the fund's overperformance. Overperformance is the fund's return in excess of the benchmark return for the period. For example, assume a fund charges a base management fee of 0.40% of AUM, and receives an incentive fee of 20% of the overperformance. If the fund's return was 10%, and the benchmark return was 8%, the overperformance would be 2%. The management fee would be increased by 0.40% (20% of 2%). By way of further example, if the fund's return was −10%, and the benchmark return was −12%, the overperformance would also be 2%.

Conversely, the base management fee is reduced for underperformance. Using the fund described in the preceding paragraph, if the fund's return were 10% and the benchmark return were 12%, the base management fee would be reduced by 0.40% to zero.

Each year, the manager is taxable on its incentive compensation.

What is needed a new method by of providing such compensation that enables a fund (i) to pay the manager with respect to the cumulative profits on an investor's investment over the life of the investment with the manager, even if such life spans multiple years, (ii) to have a perpetual life enabling investors to invest for as long they wish and to receive their share of the cumulative profits with respect to their investment, (iii) the manager to accumulate its share of the profits pre-tax, tax-deferred over the life of an investment, (iv) to value options/SARs no less frequently than the frequency with which the fund's shares are valued, (v) to vary the material terms of, and keep track of the terms of, options/SARs, including the exercisability period, the earliest redemption date, the early or excessive exercise fees, and the early or excessive redemption fees, (vi) to issue options/SARs with a strike price that is not less than the fair market value of the underlying stock immediately before the issuance, (vii) to issue new growth options/SARs and to keep track of the same in the same manner as contribution options/SARs, (viii) to keep track of the relationship of options/SARs to outstanding fund shares (i.e., shares and options/SARs related to each other), (ix) upon redemption of shares, or election to redeem shares, to identify the options/SARs related to such redeemed shares and determine the manager's exercise rights and conditions, (x) upon an exercise of options/SARs, or an election to exercise options/SARs, to identify the shares related to such options/SARs and determine the investor's redemption rights and conditions, (xi) to finance orphaned options/SARs, (xii) to reassign orphaned options/SARs according to a prescribed optimization process, (xiii) to provide investors with online access to their accounts including the details of options/SARs granted with respect to the investor's investment in the fund and the ability to redeem shares online, and (xiv) to provide managers with online access to their accounts including the details of their options/SARs and the ability to exercise options/SARs online.

5. Closed-End 40 Act Funds

The current methods of incentive compensation for closed-end 40 Act fund managers are short-term and fail to reward managers for maximizing risk-adjusted returns on an investment with the manager that continues for more than one year. Consequently, current methods of closed-end 40 Act fund manager incentive compensation fail to align managers with the interests of multi-year investors in maximizing long-term wealth creation.

Under the current method of incentive compensation, investors are charged based on performance they may or may not have received. Investors are charged for the last 36 months of performance, regardless of how long they have been invested. As a result, an investor can pay for overperformance the investor did not receive, or fail to receive credits for underperformance the investor incurred. Moreover, each year the manager is taxable on its incentive compensation.

What is needed a new method by of providing such compensation that enables a fund (i) to pay the manager with respect to the cumulative profits on an investor's investment over the life of the investment with the manager, even if such life spans multiple years, (ii) to have a perpetual life enabling investors to invest for as long they wish and to receive their share of the cumulative profits with respect to their investment, (iii) the manager to accumulate its share of the profits pre-tax, tax-deferred over the life of an investment, (iv) to value options/SARs no less frequently than the frequency with which the fund's shares are valued, (v) to vary the material terms of, and keep track of the terms of, options/SARs, including the exercisability period, the earliest redemption date, the early or excessive exercise fees, and the early or excessive redemption fees, (vi) to issue options/SARs with a strike price that is not less than the fair market value of the underlying stock immediately before the issuance, (vii) to issue new growth options/SARs and to keep track of the same in the same manner as contribution options/SARs, (viii) to keep track of the relationship of options/SARs to outstanding fund shares (i.e., shares and options/SARs related to each other), (ix) upon redemption of shares, or election to redeem shares, to identify the options/SARs related to such redeemed shares and determine the manager's exercise rights and conditions, (x) upon an exercise of options/SARs, or an election to exercise options/SARs, to identify the shares related to such options/SARs and determine the investor's redemption rights and conditions, (xi) to finance orphaned options/SARs, (xii) to reassign orphaned options/SARs according to a prescribed reassignment process, (xiii) to provide investors with online access to their accounts including the details of options/SARs granted with respect to the investor's investment in the fund and the ability to redeem shares online, and (xiv) to provide managers with online access to their accounts including the details of their options/SARs and the ability to exercise options/SARs online.

6. Incentive Compensation for Manager Employees

The current methods of incentive compensation for fund manager employees are short-term and fail to reward such employees for maximizing risk-adjusted returns on investments with the manager that continue for more than one year. Consequently, current methods of fund manager incentive compensation fail to align fund managers with the interests of multi-year investors in maximizing long-term wealth creation.

Clearly what is needed is a method by which managers who are beneficiaries of FMV options/SARs can, in turn, provide incentive compensation to its employees that aligns the employees with multi-year investors and rewards them for maximizing long-term wealth creation.

### SUMMARY

In one general aspect, the present invention is directed to computer systems and methods that compute the value and other parameters related to an investment manager's incentive compensation for managing an investment fund. The investment fund that the manager provides management services to issues shares of service recipient stock comprising common class shares and restricted class shares to each investor that contributes to (or invests in) the investment fund. The common class shares participate fully in profits and losses, after expenses, of the investment fund, but the restricted class shares do not participate in profits and losses of the investment fund. For each such contribution, the fund also issues fund alignment rights to the manager as the incentive compensation, where the number of fund alignment rights issued to the manager equals the number of restricted class shares issued to the investor. The fund alignment rights can be, for example, FMV options or FMV SARs, that have as their underlier a share of the common class shares. As such, upon exercise of a fund alignment right by the manager, the compensation payable to the manager is not greater than (i) an excess of a fair market value of a common class share on the date of exercise over (ii) a fair market value of a common class share on the date the fund alignment rights were issued to the manager. Each fund alignment right has an adjustable strike price that is not less than the fair market value of a share of the common class share on the date the fund alignment right was issued to the manager. Because investors often make contributions at different times, and the fund alignment rights are issued to the manager in response to an investor making a contribution, the manager is likely to have fund alignment rights with different strike prices.

At the close of a valuation period, the investment fund can upload or otherwise electronically transmit to a host computer system data about the fund so that an application server of the host computer system can compute, among other things, (i) the common class share NAV, (ii) the restricted class share NAV, (iii) the spreads for the fund alignment rights, and (iv) the value of the manager's fund alignment rights. Computation of the spread, per fund alignment right, can involve computing a difference between (i) the common class share NAV and (ii) a current value of the adjustable strike price for each fund alignment right. The application server can compute the value of the fund alignment rights using an option valuation model. The application server can also compute the fund NAV once the fund alignment rights spread is computed. A web server of the host computer system hosts a webpage, accessible to the investment fund via an electronic communication network (e.g., the Internet), that posts the common class share and restricted class share NAVs, the fund alignment right spread, and/or the value of the fund alignment rights. The webpage could also post other relevant information pertinent to the fund as described further below.

In various implementations, the number of common class and restricted class shares issued by the fund is fixed on the issuance date. Also, the strike price for the fund alignment rights preferably is never less than the common class share NAV on the date the fund alignment rights were granted. In addition, the fund alignment rights preferably do not include any other feature for the deferral of compensation. Advantageously, therefore, embodiments of the invention provide a mechanism by which a fund, regardless of type of fund, can provide an investor with a specified share of cumulative profits attributable to an investment over the life of the investment in the fund.

Further benefits and areas of applicability of the present invention will become apparent from the detailed description provided hereinafter. It should be understood that the detailed description and specific examples, while indicating the embodiments of the invention, are intended for purposes of illustration only and are not intended to limit the scope of the invention.

Embodiments of the invention provide several advantages over the prior art, for example, as follows.

Perpetual Investment Life. Embodiments enable a fund to have a perpetual life enabling investors to invest for as long they wish and to receive their share of the cumulative profits with respect to their investment.

Alignment. Embodiments create a partnership between manager and an investor whereby each party shares in cumulative profits over the life of the investment (or such shorter time as the parties agree) in the percentages the parties specify, even if the life of such investment continues for more than one year.

Greater Returns. Embodiments provide investors with greater capital accumulation as compared to the prevailing methods.

Manager Alignment Advantage. Embodiments enable managers to provide investors with alignment through a true, side-by-side cumulative profit-sharing accumulation that avoids erosion from interim crystallization of profits or from interim distributions to reimburse the manager for yearly income taxes.

Accumulation without Erosion. Embodiments enable the investor's capital to grow and compound in its entirety without erosion from interim crystallization of profits or from interim distributions to reimburse the manager for yearly income taxes.

Investor Control. Embodiments enable the investor to control the timing of the manager's crystallization of its share of the cumulative, pre-tax profits.

Investor Alerts. Embodiments enable the investor to receive advance notice of manager withdrawals of the manager's share of profits and the ability to withdraw its capital at the same time.

Manager Accumulation Advantage. Embodiments enable the manager to accumulate capital with respect to a given amount of contributions over a period that is unaffected by the rate at which such contributions are withdrawn and replaced (i.e., redemption rates), and to accumulate at the pre-tax rate of return of the fund.

Capital Structure that Avoids Two NAVs and Circular Calculations. Embodiments include a novel capital structure that enables a fund to issue FMV options/SARs where the fund's common share NAV based on outstanding shares, and common share NAV on a fully diluted basis, are equal. The applicant's capital structure avoids the creation of two different common share NAVs and the risks thereof. The applicant's method also avoids the circular calculations inherent in prior art capital structures.

Prior art capital structures use one class of stock—common stock. This method works when the price of the stock is determined without reference to the assets and liabilities of the company—for example, when the price is determined by buying and selling the stock on a public market. In such case, the company simply issues options/SARs on a specified number of shares at the share price that exists at the time of the grant. For example, suppose a company has 1,000,000 common shares outstanding and trading on a public exchange. Suppose the closing price on March 1 is $100 per share. If the company wanted to issue options/SARs providing 20% of the profits, it would issue an option/SAR with respect to 250,000 shares (250,000/1,250,000=20%) at a strike price of $100 per share (aggregate strike price of $250,000,000). The stock price may rise or fall immediately after the option/SAR grant. In any event, the market considers the issuance of the option/SAR and determines the FMV of the shares.

When this one class method is applied to investment companies, a couple of problems arise. The price of a common share of an investment company is derived from the gross value of the securities the fund holds, less expenses and liabilities, divided by the number of shares outstanding. The option/SAR spread is based on the VUS, which is based on the common share NAV. The common share NAV is based on the option/SAR spread, a liability of the fund. As a result, the calculation of the common share NAV under the one class of equity method is circular. It is impossible to derive the value of the common shares, or the value of the option/SAR, independently without reference to the other.

The prior art one class capital structure also creates two different NAVs, one based on outstanding shares and one based on outstanding shares plus shares subject to the option/SAR (i.e., fully diluted NAV). Under one prior art method, the common share NAV is calculated by including the strike price as an asset of the fund. For example, suppose an investor were to contribute $100 and receive 10 shares at a NAV of $10 per share. To provide the manager with 20% of the profits, the fund would issue an option/SAR with respect to 2.5 shares at a strike price of $10 per option/SAR. If the strike price is included as an asset of the fund (i.e., a receivable), then the share NAV on a fully diluted basis would be $10 ($125 divided by 12.5 shares). The problem is that under generally accepted accounting principles (“GAAP”), the fund has only $100 of assets. Consequently, the GAAP NAV on a fully diluted basis would be only $8.

The second problem with such prior art method, when applied to funds, is that common share NAV cannot be calculated by reference to the fund's return. For example, if the fund appreciated 100% to $200, the common share NAV should appreciate 100% as well. But the non-GAAP NAV would appreciate by 80% from $10 to $18 ($225 divided by 12.5 shares). The GAAP NAV, on a fully diluted basis, would appreciate by only 100%, from $8 to $16 ($200 divided by 12.5 shares).

One ostensible solution is to lower the strike to 20% of the GAAP assets. But this solution would result in an option/SAR with a strike price that is less than the FMV of the shares immediately after the investor's investment.

In one general aspect according to the present invention, the fund issues two classes of stock to an investor—a participating class and a non-participating class. Participating shares and nonparticipating shares issued with respect to a contribution are “related” to each other. The participating (or “common”) class shares represent a proportional undivided interest in the fund's profits and losses of the fund. The non-participating (or “restricted”) class does not participate in new profits but does participate in profits and losses at fund NAVs less than the NAV at the time of issuance of the shares. The NAV of a nonparticipating or restricted share is equal to the NAV of a related participating share, but not greater than the maximum NAV. The maximum NAV is the NAV at the date of issuance (unless adjusted). By using these two classes of stock, the issuance of fund alignment rights according to the present invention does not dilute the common stock and the strike price of the fund alignment rights upon issuance is equal to the price of the common stock immediately before the issuance.

Option/SAR Customization. Embodiments enable the fund to customize the terms of each profit sharing arrangement (or partnership) with respect to each investment by an investor, and to vary the material terms of, and keep track of the terms of, options/SARs, including the exercisability period, the earliest redemption date, the early or excessive exercise fees, and the early or excessive redemption fees, the number and value of underlying shares, the strike price, the strike price increases or decreases, the spread, the number and value of the related common shares, the number and value of the related restricted shares, the NAV of a related common share, the maximum NAV with respect to a related restricted share, the NAV of a related restricted share, the issuance of new growth options/SARs, the financing of options/SARs and the optimization reassignment process.

New Growth Options. Embodiments enable a fund to issue FMV options/SARs with respect to new growth or profits and to keep track of the same in the same manner as contribution options/SARs.

Financing. Embodiments enable a fund to finance orphaned options/SARs and thereby continue the life of the options/SARs beyond the redemption of shares related to such orphaned options/SARs.

Optimized Reassignment. Embodiments enable a fund to reassign orphaned options/SARs according to a prescribed optimization process.

Daily Valuation. Embodiments enable a fund to value options/SARs no less frequently than the frequency with which the fund's shares are valued.

FMV Strike Price. Embodiments enable a fund to issue options/SARs with a strike price that is not less than the fair market value of the underlying stock immediately before the issuance.

Relatedness. Embodiments enable a fund to keep track of the relationship of contribution options/SARs to outstanding fund shares (i.e., shares and options/SARs issued in exchange for a contribution are related to each other), the relationship of common shares and restricted shares (i.e., common shares and restricted shares issued in exchange for a contribution are related to each other), and the relationship of new growth options/SARs to outstanding fund shares (i.e., new growth options/SARs issued with respect to new growth are related to the outstanding shares issued in exchange for the contributions that produced the new growth).

Redemption and Exercise Rights. Embodiments enable a fund, upon redemption of shares, or election to redeem shares, to identify the options/SARs related to such redeemed shares and determine the manager's exercise rights and conditions.

Exercise and Redemption Rights. Embodiments enable a fund, upon an exercise of options/SARs, or an election to exercise options/SARs, to identify the shares related to such options/SARs and determine the investor's redemption rights and conditions.

Investor Access. Embodiments enable a fund to provide investors with online access to their accounts including the details of options/SARs granted with respect to the investor's investment in the fund and the ability to redeem shares online.

Manager Access. Embodiments enable a fund to provide managers with online access to their accounts including the details of their options/SARs and the ability to exercise options/SARs online.

Tax-Deferred Accumulation on NQDC. With respect to NQDC that is taxable at a specified date in the future, embodiments enable a Manager to defer taxation of the future growth of the NQDC beyond the date the NQDC is taxable.

Tax-Deferred Accumulation on Manager Investments. With respect to Manager's investments in a Fund, whether the source of such investment is after-tax incentive compensation or other, embodiments enable a Manager to defer taxation of the future growth of the investment to the end of the life of the investment.

Manager Delivery of Tax-Deferred Benefits to Partners. Embodiments enable a Manager that is taxable as a partnership to receive tax-deferred incentive compensation and, in turn, provide tax-deferred incentive compensation to the Manager's partners.

Manager Delivery of Tax-Deferred Benefits to Employees. Embodiments enable a Manager to receive tax-deferred incentive compensation and, in turn, provide tax-deferred incentive compensation to the Manager's employees without tax cost to owners of the equity capital of the Manager (whether a partner of a Manager taxable as a partnership or a shareholder of a Manager taxable as either an S corporation or a C corporation).

Embodiments of the present invention can enable a hedge fund to issue FMV options/SARs and provide the manager and each investor with a specified share of the cumulative, end-of-performance cumulative profits on each of the investor's investments, without erosion from interim crystallization of incentive compensation, and even if the performance period is greater than one year.

Embodiments of the present invention can enable a private equity fund to be perpetual, whereby investors can contribute and redeem at their discretion and receive their specified share of the cumulative profits on their investment across all deals in which the investment participates, regardless of the period of the investment or number of deals. Embodiments enable a private equity fund to issue FMV options/SARs with respect to each deal with a strike price that is not less than the FMV of the underlying shares of the fund immediately prior to the issuance, to reinvest the proceeds from a deal in another deal, and to adjust the strike prices of the options/SARs on unrealized deals in a way that ensures (i) the investor receives its specified percentage of cumulative profits across all deals, and (ii) the strike price is never less than the fair market value of the underlying shares at the date of issuance.

Embodiments of the present invention can enable a private long only fund to issue FMV options/SARs and provide the manager and each investor with a specified share of the cumulative, end-of-performance cumulative profits on each of the investor's investments, without erosion from interim crystallization of incentive compensation, and even if the performance period is greater than one year.

Embodiments of the present invention can enable a closed-end 40 Act fund to issue FMV options/SARs and provide the manager and each investor with a specified share of the cumulative, end-of-performance cumulative profits on each of the investor's investments, without erosion from interim crystallization of incentive compensation, and even if the performance period is greater than one year.

Embodiments of the present invention can enable the manager to, in turn, pass through the long-term cumulative profit-sharing benefits of FMV options/SARs to its key employees and thereby align them with investors' interests in maximizing investment returns over the life of multi-year investments.

### BRIEF DESCRIPTION OF THE DRAWINGS

For a more complete understanding of embodiments this invention reference should now be had to the embodiments illustrated, by way of example, in greater detail in the accompanying drawings and described below.

FIGS. 1A-1I illustrate a prior art method by which a hedge fund provides incentive compensation to a manager with respect to a particular contribution made by an investor to the fund (the “Annual Crystallization Method”).

FIGS. 2A-2J illustrate a method according to an embodiment of the present invention by which a hedge fund provides incentive compensation in the form of FMV options/SARs to a manager with respect to a particular contribution made by an investor to the fund.

FIGS. 3A-3B illustrate a prior art method by which a company issues FMV options/SARs, the dilutive effect on stock price, and the circular nature of the valuation when applied to investment companies.

FIGS. 4A-4B illustrate a method according to an embodiment of the present invention by which a fund issues FMV options/SARs, the non-dilutive effect on stock price, and the ability to calculate the common share NAV and option/SAR values independently using the fund's return after all fees and expenses other than the option/SAR spread.

FIGS. 5A-5B illustrate a method according to an embodiment of the present invention for granting new growth FMV options/SARs.

FIG. 6 illustrates the financing of orphaned options/SARs according to an embodiment of the present invention.

FIGS. 7A and 7B illustrate the optimization reassignment process according to an embodiment of the present invention.

FIGS. 8A-8B are tables that illustrate a method according to an embodiment of the present invention by which a fund issues options/SARs with respect to deferred compensation owed the manager.

FIG. 9 is a table that illustrates a method according to an embodiment of the present invention by which a fund issues options/SARs with respect to the manager's investment in the fund.

FIG. 10 illustrates a computer system according to an embodiment of the present invention.

FIG. 11 is a flow chart of a process performed by the computer system of FIG. 10 according to an embodiment of the present invention.

FIG. 12 illustrates techniques for providing fund alignment rights when the manager is taxed as a partnership.

FIG. 13 illustrates techniques for providing fund alignment rights when the manager is taxed as a S corporation or a C corporation.

### DETAILED DESCRIPTION

Embodiments of the present invention are described hereinafter with reference to the accompanying drawings. Embodiments may be in many different forms and should not be construed as limited to the embodiments set forth herein. Rather, the embodiments are provided as examples of the invention to those skilled in the art. It will be understood that all alternatives, modifications, and equivalents are intended to be included within the spirit and scope of the invention as defined by the appended claims.

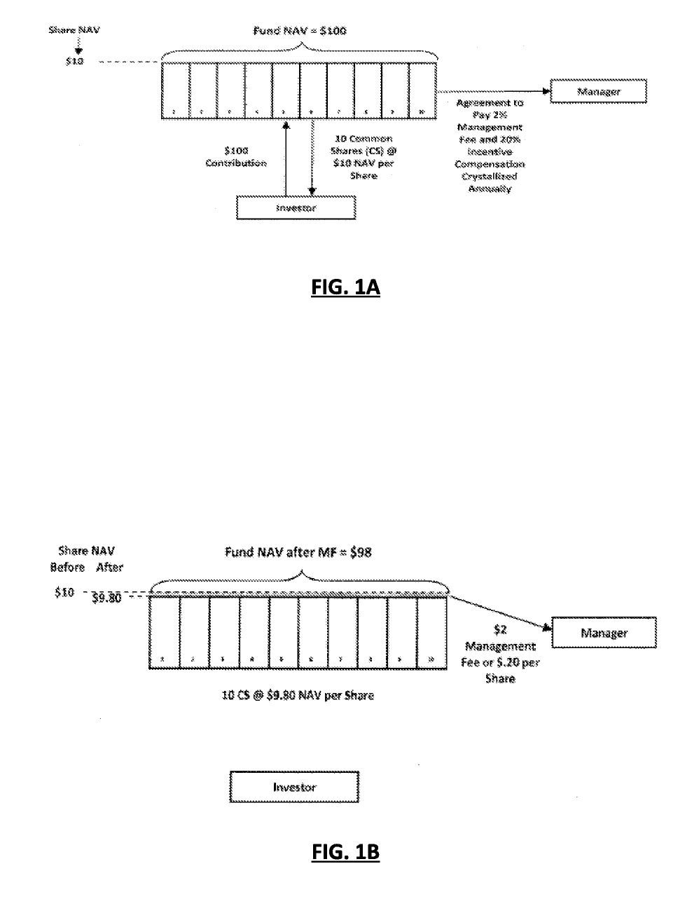

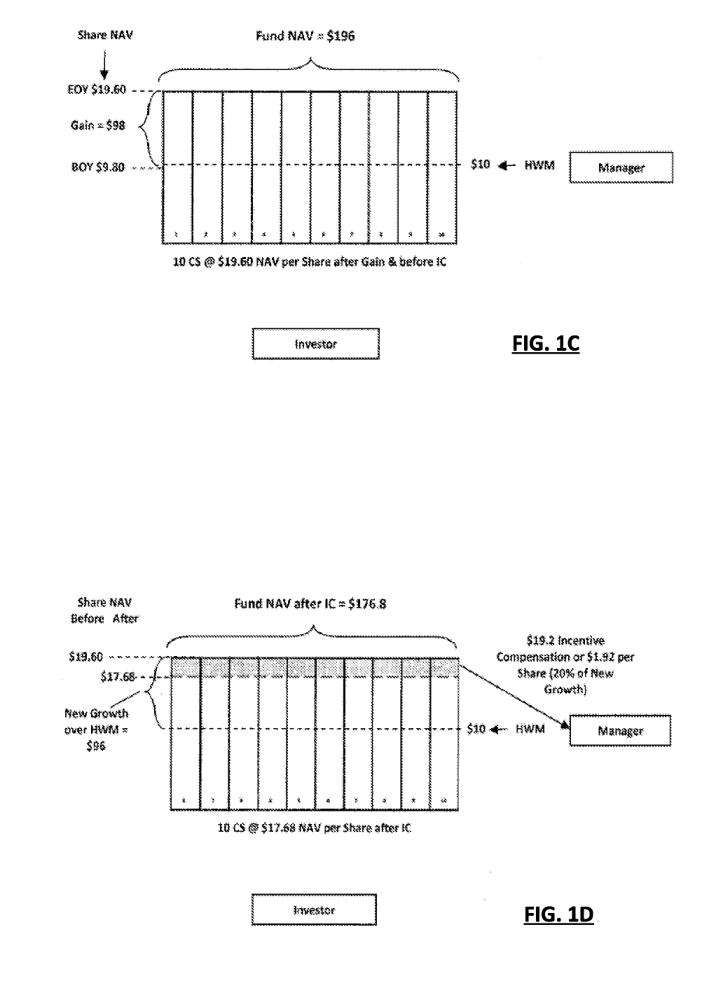

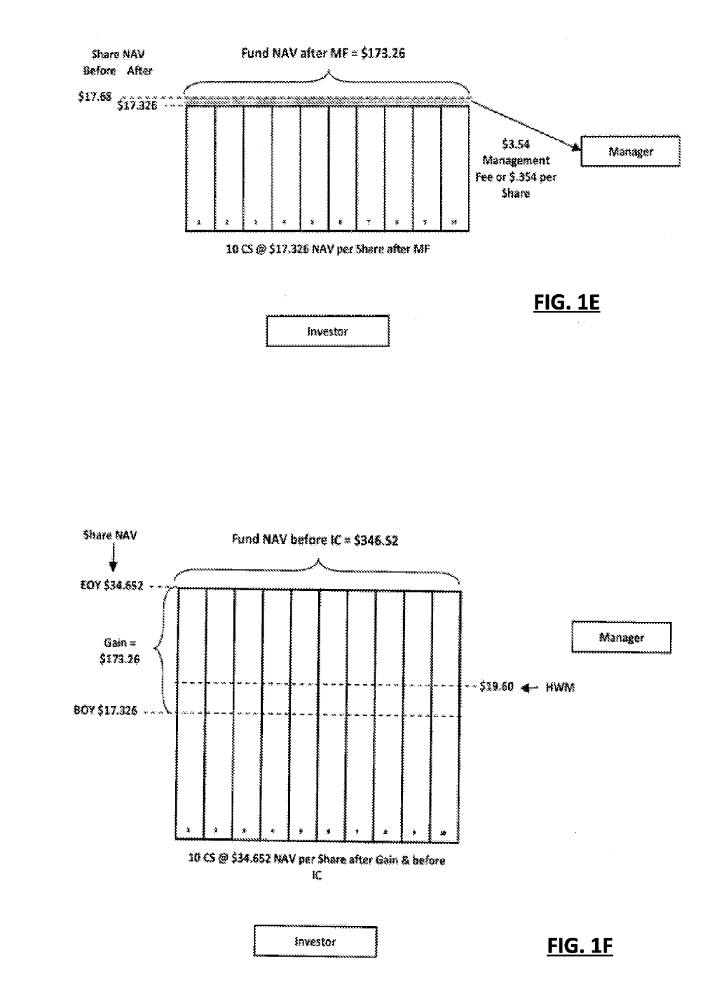

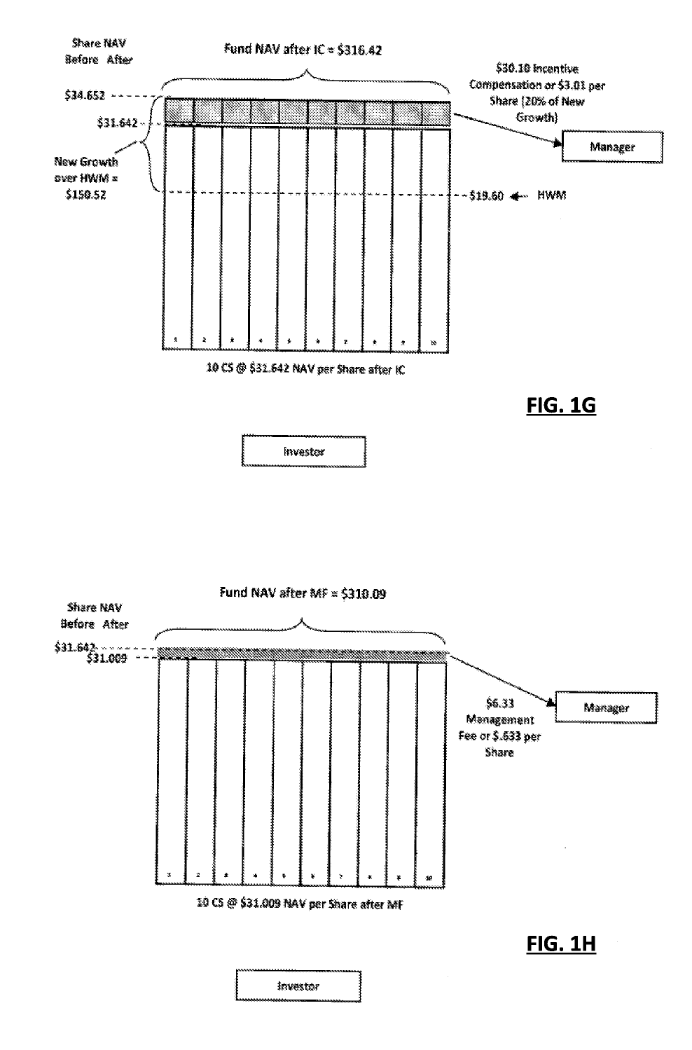

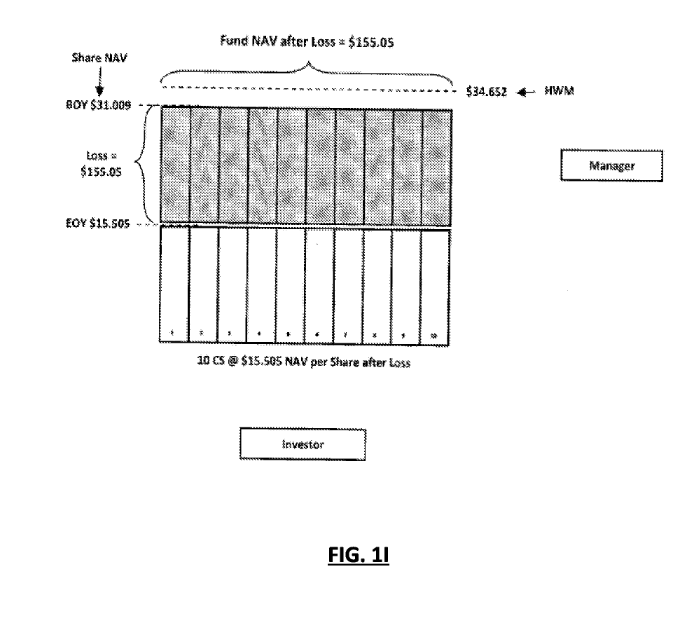

Turning initially to FIGS. 1A-I, there is illustrated a prior art investment manager incentive compensation method. A manager provides services to a hedge fund and, in exchange, the fund agrees to provide incentive compensation to the manager consisting of a specified percentage of the calendar year profits the manager generates for the fund's investors. Typically, the manager earns incentive compensation with respect to new profits or new growth only. If the value of the investor's shares as of the end of the year is less than the highest previous year-end value (“high water mark”), then no incentive compensation is earned for that year.

Annual Crystallization vs. End-of-Performance Crystallization.

Table 1 below illustrates this prior art incentive compensation method for hedge fund managers (“Annual Crystallization Method”), and compares it to a method where profits are shared at the end of a 4-year investment life (“End-of-Performance Crystallization Method”). Under the Annual Crystallization Method, the manager receives a specified percentage of “new profits” each year. New profits are profits in excess of the highest previous value attained, or “high water mark,” with respect to an investment. Under the End-of-Performance Crystallization Method, the cumulative profits are divided at the end of the life of the investment. For purposes of simplicity, the illustration below assumes no management fees.

TABLE 1

| | | | Annual Crystallization | | | | End-of-Performance (EOP) Crystallization | | | | |
|---|---|---|---|---|---|---|---|---|---|---|---|
| | | | Fund | | | Fund | | | | Fund NAV & | |
| | | | NAV & | | | NAV & | | | | Investor's | Investor's EOP |
| | | | Investor's | | Incentive | Investor's | Fund | | IC if | Balance if | Crystallization |
| | | Contribution | Balance | Profit | Compensation | Balance | NAV | Profit | Redemption | Redemption | Advantage |
| Year | Return | (BOY) | (BOY) | (Loss) | (IC) | (EOY) | (BOY) | (Loss) | Occurs | Occurs (EOY) | (EOY) |
| 1 | 100% | $100 | $100 | $100 | −$20 | $180 | $100 | $100 | −$20 | $180 | $0 |
| 2 | 100% | | $180 | $180 | −$36 | $324 | $200 | $200 | −$60 | $340 | $16 |
| 3 | −50% | | $324 | −$162 | $0 | $162 | $400 | −$200 | −$20 | $180 | $18 |
| 4 | 100% | | $162 | $162 | $0 | $324 | $200 | $200 | −$60 | $340 | $16 |
| 5 | 100% | | $324 | $324 | −$65 | $583 | $400 | $400 | −$140 | $660 | $77 |

Table 2 below is the same as above for Annual Crystallization, except it includes a 2% management fee that is assumed to be paid at the beginning of each year.

TABLE 2

| | | Contri- | | | | | | NAV | New | | NAV |
|---|---|---|---|---|---|---|---|---|---|---|---|
| | | bution | NAV before | | NAV after | | | before IC | Growth | | after IC |
| Year | Return | (BOY) | MF (BOY) | MF | MF (BOY) | Profit (Loss) | HWM | (EOY) | (EOY) | IC | (EOY) |
| | | | | 2% | | | | | | 20% | |
| 1 | 100% | $100 | $100.000 | −$2.000 | $98.000 | $98.000 | $100.000 | $196.000 | $96.000 | −$19.200 | $176.800 |
| 2 | 100% | | $176.800 | −$3.536 | $173.264 | $173.264 | $196.000 | $346.528 | $150.528 | −$30.106 | $316.422 |
| 3 | −50% | | $316.422 | −$6.328 | $310.094 | −$155.047 | $346.528 | $155.047 | −$191.481 | $0.000 | $155.047 |
| 4 | 100% | | $155.047 | −$3.101 | $151.946 | $151.946 | $346.528 | $303.892 | −$42.636 | $0.000 | $303.892 |
| 5 | 100% | | $303.892 | −$6.078 | $297.814 | $297.814 | $346.528 | $595.628 | $249.100 | −$49.820 | $545.808 |

As an example of the annual crystallization method, assume an investor contributes $100 to fund on January 1, and the fund issues common series shares giving the investor full participation in profits and losses after expenses, management fees and incentive compensation. Common series stock qualifies as Section 305 stock under Internal Revenue Code. The Fund agrees to pay the manager management fee at annual rate of 2% of fund assets and incentive compensation at the end of each calendar year equal to 20% of profits for the year in excess of the previous high year-end NAV for the investment. FIG. 1A illustrates the contribution of this example and FIG. 1B illustrates payment of the management fee. For simplicity, it is assumed the management fee is paid annually at the beginning of each year. In this example, the management fee is $2 or $0.20 per share. Thus, the share NAV after paying the management fee reduces from $10.00 to $9.80, with a Fund NAV of $98 ($9.80/share times 10 shares). The highwater mark (HWM) is $10/share.

FIG. 1C illustrates 100% growth during the first year before crystallization of the incentive compensation. The share NAV doubled from $9.80 to $19.60 (the new HWM), such that the Fund NAV is $196. FIG. 1D illustrates the payment of the incentive compensation after the first year. The compensation is 20% of net growth (so 20% of $96, or $19.20, or $1.92 per share), which reduces the share NAV to $17.68 and the fund NAV to $176.80. FIG. 1E illustrates payment of the management fee at the beginning of the second year. The management fee is $3.54 (2% of fund assets), which reduces the share NAV to $17.326 and the fund NAV to $173.26.

FIG. 1F illustrates 100% growth during the second year. The share NAV doubled from $17.326 to $34.652 (the new HWM), and the fund NAV is $346.52 prior to paying the incentive compensation. FIG. 1G illustrates the incentive compensation for the second year. The manager is paid $30.10, or $3.01 per share, which is 20% of the net fund growth, which is $15.052 per share (computed as new HWM, $34.652, minus prior HWM, $19.60). FIG. 1H illustrates the management fee at the beginning of the third year. It is $6.33, which reduces the share NAV to $31.009 and the fund NAV to $310.09.

FIG. 1I shows a 50% decline during year three. The share NAV reduced from $31.009 to $15.505. As this example shows, under the Annual Crystallization Method the manager can receive a greater share of the cumulative profits than the 20% rate of sharing of annual profits. In this example, the manager received $49.3 total in profits, even though the investor would receive only $55.05 if it redeemed after year three. In percentage terms, the manager would have received 47% of the cumulative profits and the investor only 53%. It is even possible for the manager to profit while the investor receives no profits or loses money.

On the other hand, according to various embodiments of the present invention, a manager provides services to a hedge fund, and in exchange, and with respect to each contribution or investment received from an investor, the fund grants the manager fund alignment rights, such as a FMV option or FMV SAR. The FMV option/SAR is not taxable to the manager until the manager elects to exercise the option/SAR. As a result, the FMV option/SAR produces the result of keeping all the contributions and growth thereon invested in the fund, without erosion from interim distributions or taxation, until the manager exercises or the investor redeems, even if such exercise or redemption is after many years.

Table 3 below illustrates how fund alignment rights (e.g., FMV options or SARs) provide the same economic results as the End-of-Performance Crystallization Method shown in FIGS. 1A-1I. For purposes of simplicity, management fees are assumed to be zero.

TABLE 3

| | | | FMV Option/SAR (BOY) | | | | FMV Option/SAR (EOY) | | | |
|---|---|---|---|---|---|---|---|---|---|---|
| | | | Value of | | | Investor's | Value of | | | Investor's |
| | | | Underlying | | | Balance if | Underlying | | | Balance if |
| | | Contribution | Shares | Strike | | Option/SAR | Shares | Strike | | Option/SAR |
| Year | Return | (BOY) | (VUS) | Price | Spread | Exercised | (VUS) | Price | Spread | Exercised |
| 1 | 100% | $100 | $20 | $20 | $0 | $100 | $40 | $20 | $20 | $180 |
| 2 | 100% | | $40 | $20 | $20 | $180 | $80 | $20 | $60 | $340 |
| 3 | −50% | | $80 | $20 | $60 | $340 | $40 | $20 | $20 | $180 |
| 4 | 100% | | $40 | $20 | $20 | $180 | $80 | $20 | $60 | $340 |
| 5 | 100% | | $80 | $20 | $60 | $340 | $160 | $20 | $140 | $660 |

Table 4 below is the same as above, except it includes a 2% management fee that is assumed to be paid at the beginning of each year.

TABLE 4

| | | | | | NAV | | Fund | | Fund | | |
|---|---|---|---|---|---|---|---|---|---|---|---|
| | | Contribution | NAV before | | after MF | Spread | Assets | Profit | Assets | Spread | Fund NAV |
| Year | Return | (BOY) | MF (BOY) | MF | (BOY) | (BOY) | (BOY) | (Loss) | (EOY) | (EOY) | (EOY) |
| 1 | 100% | $100 | $100.00 | −$2.000 | $98.00 | 0 | $98.00 | $98.00 | $196.00* | −$19.20 | $176.80 |
| 2 | 100% | | $176.80 | −$3.536 | $173.97 | −18.49 | $192.46 | $192.46 | $384.93* | −$56.99 | $327.94 |
| 3 | −50% | | $327.94 | −$6.559 | $322.70 | −55.67 | $378.37 | −$189.18 | $189.18* | −$17.84 | $171.35 |
| 4 | 100% | | $171.35 | −$3.427 | $168.61 | −17.15 | $185.76 | $185.76 | $371.52* | −$54.30 | $317.21 |
| 5 | 100% | | $317.21 | −$6.344 | $312.14 | −53.03 | $365.17 | $365.17 | $730.34* | −$126.07 | $604.27 |

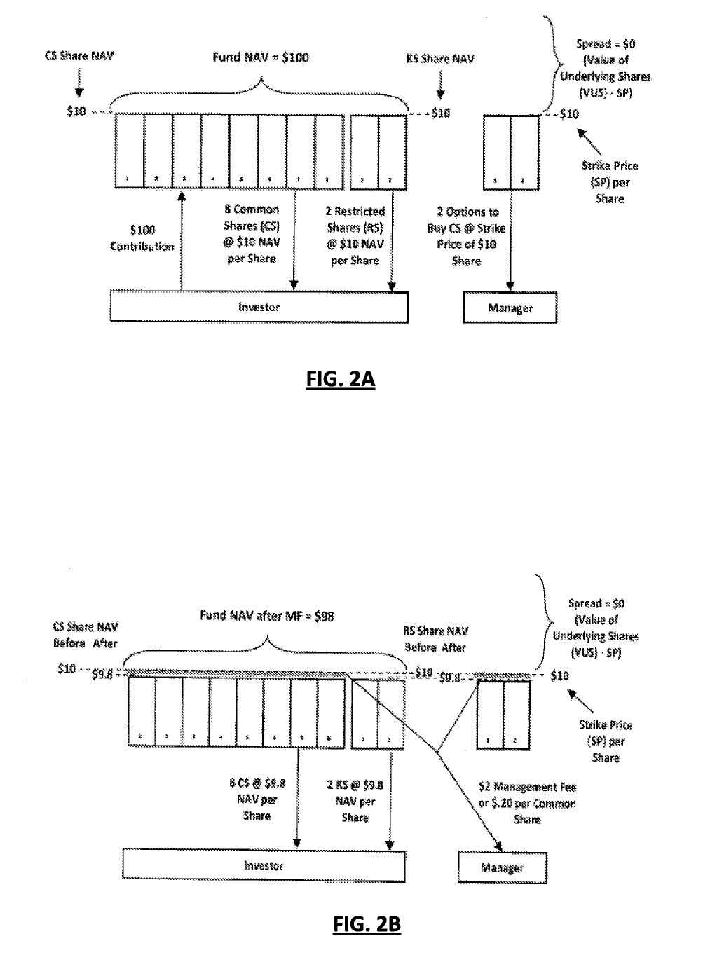

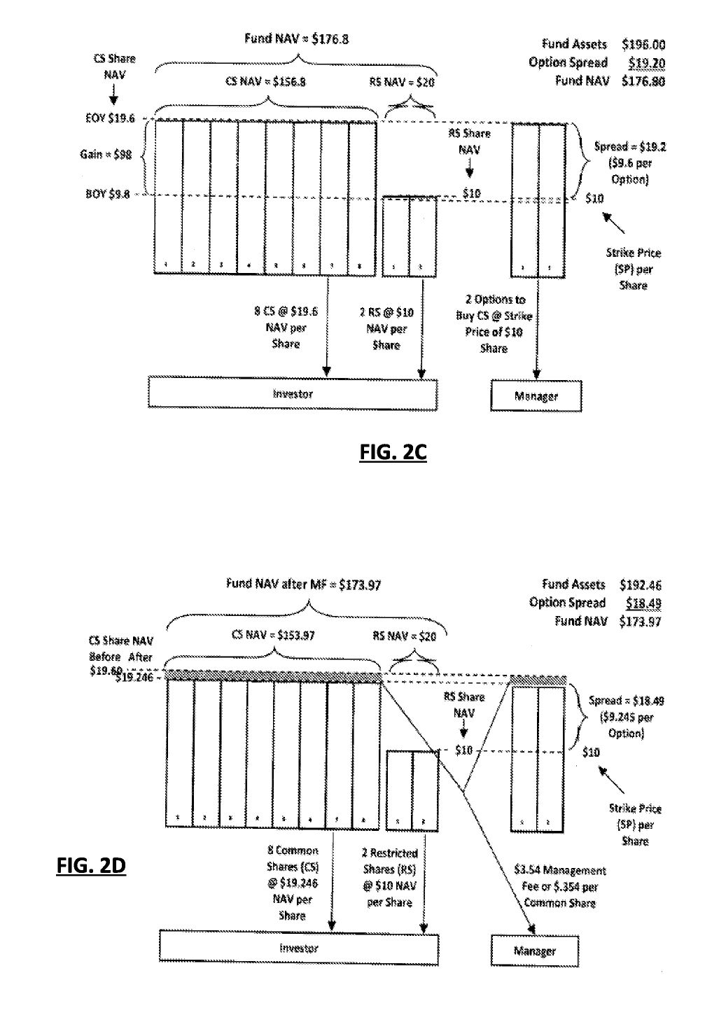

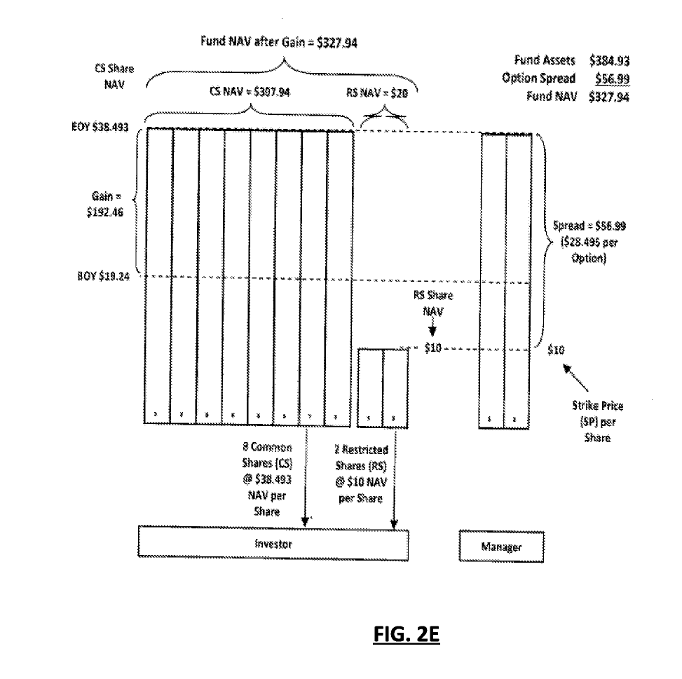

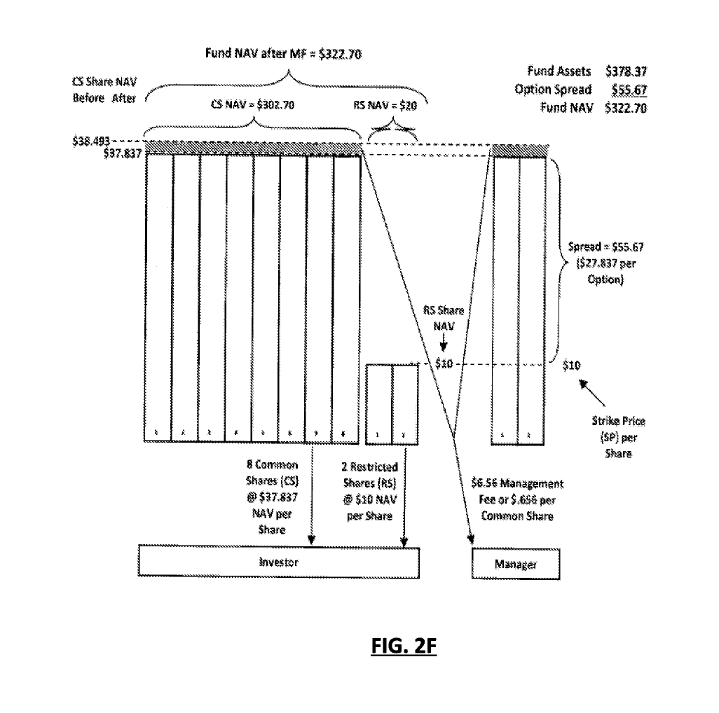

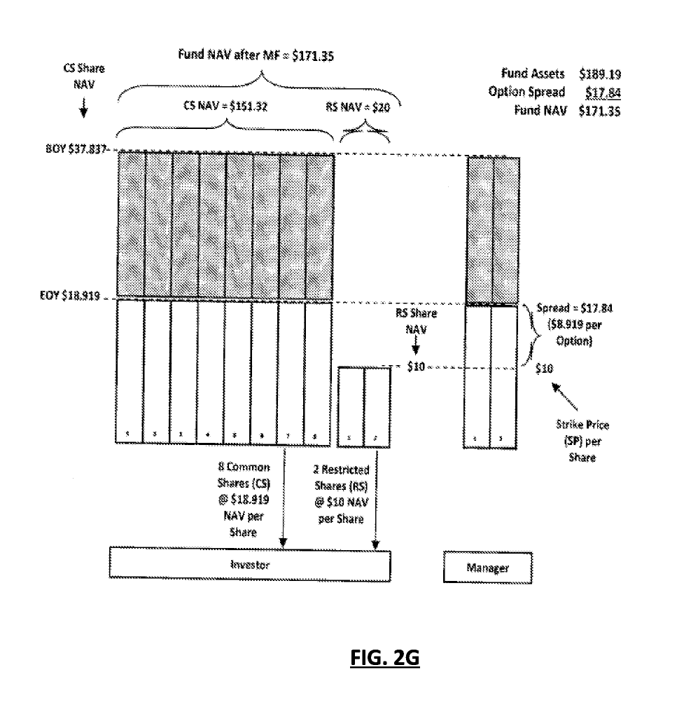

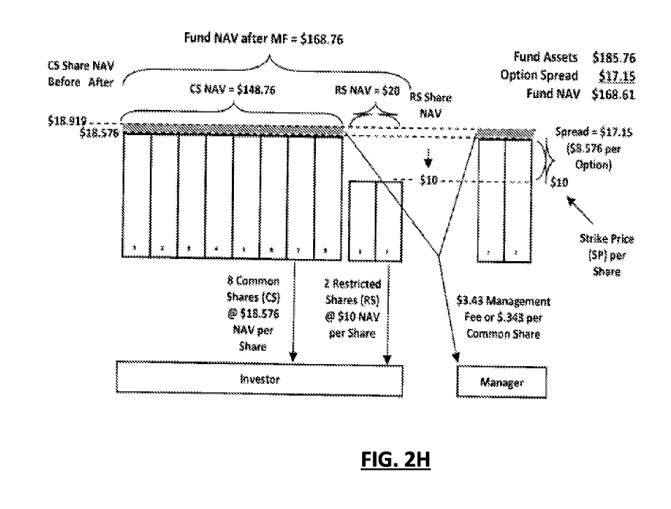

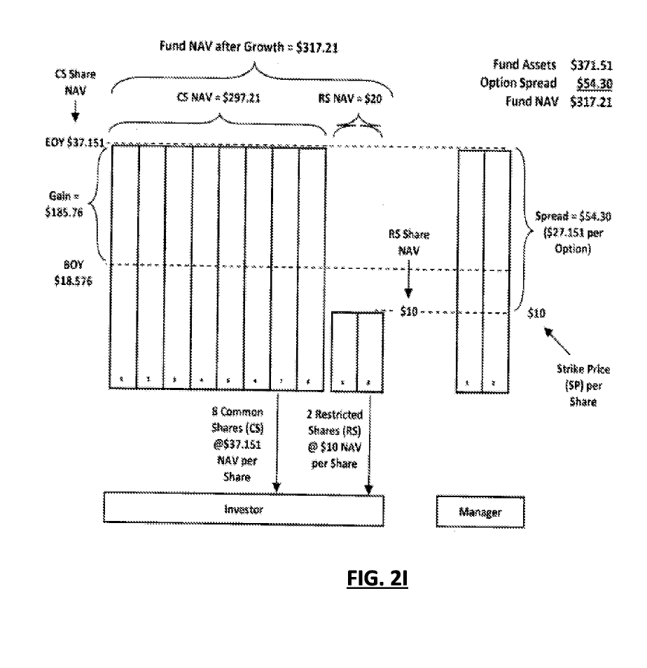

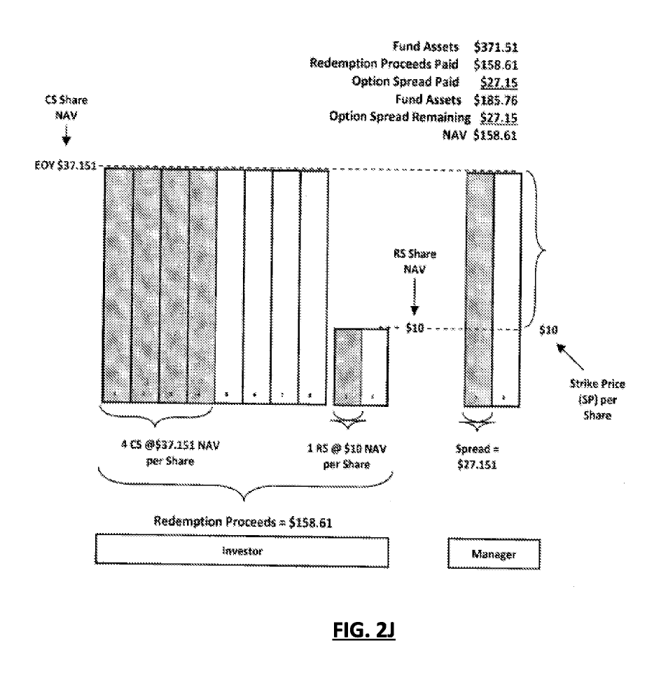

FIGS. 2A-2J illustrate an example of fund alignment rights according to an embodiment of the present invention. Assume an investor contributes $100 to fund, and the fund issues common series shares giving investor full participation in profits and losses after expenses, management fees and incentive compensation, and restricted shares that do not participate in profits but do participate in losses. Common series stock qualifies as Section 305 stock. The Fund agrees to pay manager management fee at annual rate of 2% of fund assets and incentive compensation in the form of FMV options/SARs designed to provide the manager with 20% of the cumulative profits at the time the manager exercise the options/SARs. FIG. 2A illustrates the contribution and FIG. 2B illustrates the management fee. For simplicity, it is assumed the management fee is paid annually at the beginning of each year. FIG. 2A shows that at inception the investor receives 8 common shares at $10 NAV per share and 2 restricted shares at $10 NAV per share. The fund manager receives 2 options to buy common shares with a strike price of $10 per share. The manager option spread therefore is $0 at issuance, as the value of the underlying shares ($10) equals the strike price. FIG. 2B shows that the manager receives a management fee of $2 (or $0.20 per common and restricted share).

FIG. 2C shows the result assuming 100% growth during the first year. The common share NAV increased to $19.6 and the Fund NAV increased to $176.80 (computed as 8 common shares at $19.60 and 2 restricted shares at $10). The spread on the fund manager's fund alignment rights is then $9.60 per option or $19.20 total.

FIG. 2D illustrates the management fee at the start of the second year. The manager is paid $3.54 as a management fee computed as $0.354 per common and restricted share. That reduces the common share NAV to $19.246 and the fund NAV to $173.97. FIG. 2E shows 100% growth again during year two. The common share NAV increased to $38.493 and the fund NAV increased to $327.94. The spread on the manager's fund alignment rights increased to $28.495/option or $56.99 total.

FIG. 2F shows the management fee at the start of the third year. The manager's fee is $6.56 total (or $0.656 per common share), which reduces the common share NAV to $37.837, the fund NAV to $322.70, and the manager's spread to $27.837 per option (or $55.67 total). FIG. 2G shows a 50% drop during the third year. The common share NAV reduced to $18.919, the fund NAV reduced to $171.35, and the manager's spread reduced to $8.919 per option (or $17.84 total) due to the 50% drop. FIG. 2H shows the management fee for year 4. The management fee was $3.43, reducing the common share NAV to $18.576, the fund NAV to $168.76, and the manager's spread to $8.576 per option (or $17.15 total). And FIG. 2I illustrates another 100% return in year 4. The common share NAV increased to $37.151, the fund NAV increased to $317.21, and the manager's spread increased to $27.151 per option (or $54.30 total).

The example of FIGS. 2A-2I shows that according to embodiments of the fund alignment rights of the present invention, the investor and manager always share cumulative profits in the specified percentages. At the end of each year, the manager had a 20% interest in the cumulative profits and the investor had an 80% interest. In this example, the restricted shares and options/SARs are associated with contributions and the common shares issued in exchange for such contributions, and with each other. Upon a redemption of common shares, specified related restricted shares are redeemed as well, and related FMV options/SARs become exercisable or become exercisable with lower early/excessive exercise fees. Likewise, upon exercise of options/SARs, the related shares become redeemable, or redeemable with lower early/excessive redemption fees. FIG. 2J illustrates a 50% redemption or 50% exercise (depending on the nature of the fund alignment rights).

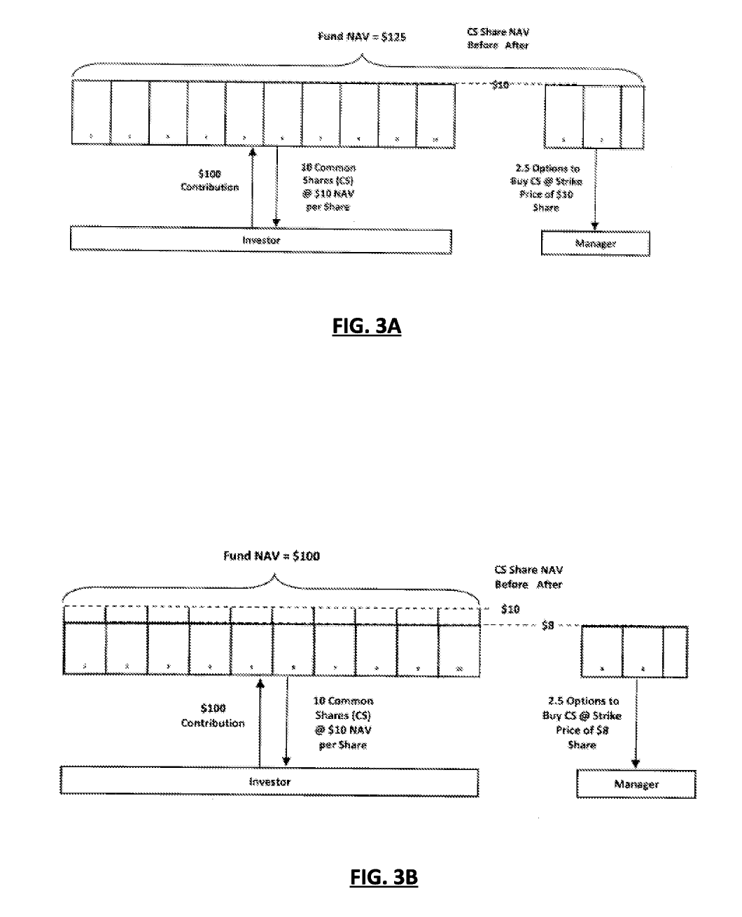

FIGS. 3A to 3B illustrate another prior art incentive compensation method. In this example, a manager provides services to a hedge fund, and in exchange, the hedge fund agrees to provide incentive compensation to the manager consisting of FMV options/SARs. But the grant of the options/SARs causes dilution and an immediate reduction of the price, or NAV, of the underlying shares.

Under the prior art method described in connection with FIGS. 3A to 3B, the company issues options/SARs with respect to sufficient additional unissued common shares to provide the specified percentage of profit. For example, if the specified profit percentage is 20%, the number of underlying shares must be 20% of the total number of shares on a fully diluted basis. Stated another way, the underlying shares would be 25% of the outstanding common shares (20% divided by (1-20%)). If the investor receives 100 shares, for example, and the manager is to receive 20% of the profits, then the manager would receive a FMV option/SAR with respect to 25 additional shares (25% (20% divided by 80%) times 100 outstanding shares), and the 25 additional shares would equal 20% of the total number of shares (125).

There are two ways to set the strike price—non-GAAP and GAAP, where “GAAP” means “generally accepted accounting principles.” Under the non-GAAP method, the strike price is treated as an asset and calculated by multiplying the total assets (which includes the strike price receivable) by the option holder's profit percentage. For example, if the investor contributes $100 and receives 100 shares at a price of $1.00 per share and wishes to provide the manager with 20% of the profits, the fund would grant an option to purchase $25 of shares (25 shares) at a strike price of $1.00 per share. The NAV per share immediately after the option grant, on a fully diluted basis, would be $1.00 ($125 of total assets divided by 125 shares).

There are two problems with this method. First, the change in the share NAV will be less than the performance of the fund's investable assets. For example, if the manager were to realize a 100% return on the $100 of investable assets, the share NAV would increase by only 80%, from $1.00 to $1.80 ($225 of assets divided by 125 shares).

Second, the strike price is not considered an asset under GAAP. Under GAAP, fund assets would be only $100 when the option is granted. To provide the manager with 20% of the profits, the fund issues an option/SAR with respect to 25 shares (20% of the total number of shares of 125) at a strike price of $20 (20% times the total assets of $100). But when the fund issues an option/SAR on $20 of shares at a strike price of $20, the “book value” per share is diluted and decreases. In the example where the investor contributes $100 and receives 100 shares at a NAV of $1.00 per share, the issuance of the option/SAR with respect to 25 shares at a strike price of $20 would reduce the share NAV, on a fully diluted basis, to $0.80.

Table 5 below illustrates the non-GAAP prior art method. It assumes a $100 investment and a 100% return at the end of the first year. Although the return on investable assets is 100%, the share NAV increase is only 80%.

TABLE 5
(non-GAAP)

| | | | | FMV Option/SAR | | | | Fund | | | No. of | | |
|---|---|---|---|---|---|---|---|---|---|---|---|---|---|
| Return on | | | Shares | | No. of | | | In- | Fund Strike | | Shares | NAV | Share |
| Investable | | Contri- | issued to | | Underlying | Strike | | vestable | Price | Total | (Fully | per | NAV |
| Assets | | bution | investor | VUS | Shares | Price | Spread | Assets | Receivable | Assets | Diluted) | Share | Change |
| | Contribution | $100.00 | 100.00 | $25.00 | 25.00 | $25.00 | $0.00 | $100.00 | $25.00 | $125.00 | 125.00 | $1.00 | |
| | Immediately | | 100.00 | $25.00 | 25.00 | $25.00* | $0.00 | $100.00 | $25.00* | $125.00 | 125.00 | $1.00 | |
| | After | | | | | | | | | | | | |
| | Contribution | | | | | | | | | | | | |
| 100% | End of | | 100.00 | $45.00 | 25.00 | $25.00 | $20.00 | $200.00 | $25.00* | $125.00 | 125.00 | $1.80 | 80.00% |
| | Year One | | | | | | | | | | | | |

Table 6 below illustrates the GAAP prior art method. This method addresses the problem with the non-GAAP method by excluding the strike price from the share NAV calculation. But it causes another problem. Immediately after the grant of the FMV option/SAR, the NAV decreases. It creates the appearance that the option/SAR strike price is less than the FMV of the underlying shares at the date of grant.

TABLE 6
(GAAP)

| | | | Shares | FMV Option/SAR | | | | | | | No.of | | |
|---|---|---|---|---|---|---|---|---|---|---|---|---|---|
| Return on | | Con- | Issued | | No.of | | | Fund | Fund Strike | | Spares | NAV | Share |
| Investable | | tribu- | to | | Underlying | Strike | | Investable | Price | Total | (Fully | per | NAV |
| Assets | | tion | Investor | VUS | Shares | Price | Spread | Assets | Receivable | Assets | Diluted) | Share | Charge |
| | Contribution | 100 | 100.00 | $20.00 | 25.00 | $20.00 | $0.00 | $100.00 | $0.00 | $100.00 | 125.00 | $1.00 | |
| | Immediately | | $100.00 | $20.00 | 25.00 | $20.00 | $0.00 | $100.00 | $0.00 | $100.00 | 125.00 | $0.80 | |
| | After | | | | | | | | | | | | |
| | Contribution | | | | | | | | | | | | |
| 100% | End of | | 100.00 | $20.00 | 25.00 | $20.00 | $20.00 | $200.00 | $0.00 | $200.00 | 125.00 | $1.60 | 100.00% |
| | Year One | | | | | | | | | | | | |

Under either the non-GAAP or GAAP prior art method, the employer uses one class of common stock and simply issues options/SARs with respect to such number of additional common shares that will provide the service provider with the intended percentage of future profits. For example, to provide an interest in 20% of future profits the employer issues an option to purchase shares that comprise 20% of the total shares. So if there were 10 shares outstanding, the option would provide the right to buy 2.5 shares (2.5/12.5=20%).

If the fund uses the non-GAAP method for setting the strike price, the fund NAV includes the strike price receivable and the aggregate strike price would be $25.00 (20% of the fund non-GAAP NAV of $125.00). The fund would issue an option/SAR with respect to 25 shares at a strike price of $10.00 per share. The non-GAAP share NAV is $10.00 immediately after the investor's investment and $10.00 immediately after the issuance of the option/SAR.

Under the GAAP method, the fund NAV would be $10.00 immediately after the investment. The fund would issue an option/SAR with respect to 25 shares with an aggregate value of $20.00 and an aggregate strike price of $20.00. Upon issuance of the option, the NAV drops from $10.00 to $8.00 ($100 of Fund NAV divided by 12.5 shares).

FIG. 3A and Tables 7-8 below illustrate the dilution and price decrease which occurs under the prior non-GAAP method. Table 7 shows the investment and grant, and Table 8 shows after a 100% return at the end of year one. In this figure and tables, “CO” indicates the contribution option or SAR, as the case may be. Table 7 shows that after grant, the common shares have a NAV of $10.00, and a diluted NAV of $8.00. After year one, as shown in Table 8, the NAV of the common shares is $18.00 outstanding/$14.40 diluted. The contribution option value of shares is also $18.00 outstanding/$14.40 diluted, and that the fund NAV increased to $180.

TABLE 7
(non-GAAP)

| | | | | NAV per Share | | |
|---|---|---|---|---|---|---|
| | | Aggregate | No. of | (Outstanding/ | Fund Assets & | |
| | | Value | Shares | Fully Diluted) | Liabilities | Fund NAV |
| Investment | CS Issued | $100 | 10 | $10.00 | | |
| and Grant | (Before Grant) | | | | | |
| | CO VUS | $25 | 2.5 | $10.00/$8.00 | | |
| | CS Issued | $100 | 10 | $10.00/$8.00 | | |
| | (After Grant) | | | | | |
| | CO SP | $25 | N/A | N/A | | |
| | CO Spread | $0 | N/A | N/A | | |

| | | |
|---|---|---|
| Assets Beginning of Year (BOY) | $0 | |
| Contribution (BOY) | $100 | |
| Strike Price | $25 | |
| Total Assets (BOY) | $125 | |
| VUS Liability/Equity (BOY) | $25 | $100 |

TABLE 8
(non-GAAP)

| | | | | NAV per Share | | |
|---|---|---|---|---|---|---|
| | | Aggregate | No. of | (Outstanding/ | Fund Assets & | |
| | | Value | Shares | Fully Diluted) | Liabilities | Fund NAV |
| 100% | CS Issued | $180 | 10 | $18.00/$14.40 | | |
| Return End | CO VUS | $45 | 2.5 | $18.00/$14.40 | | |
| of Year One | CO SP | $25 | N/A | N/A | | |
| | CO Spread | $20 | N/A | N/A | | |

| | | |
|---|---|---|
| Assets Beginning of Year (BOY) | $125 | |
| Growth End of Year (EOY) | $100 | |
| Total Assets (EOY) | $225 | |
| VUS Liability/Equity (EOY) | ($45) | $180 |

FIG. 3B and Tables 9-10 below illustrate the dilution and price decrease which occurs under the prior GAAP method. Table 9 shows the investment and grant, and Table 10 shows after a 100% return at the end of year one. Table 9 shows that after grant, the common shares have a NAV of $10.00, and a diluted NAV of $8.00. After year one, as shown in Table 10, the NAV of the common shares is $18.00 outstanding/$14.40 diluted. The contribution option value of shares is also $18.00 outstanding/$14.40 diluted, and that the fund NAV increased to $180.

TABLE 9
(GAAP)

| | | | | GAV per | NAV per | | | |
|---|---|---|---|---|---|---|---|---|
| | | | | Share | Share | | | |
| | | | | (Outstanding/ | (Outstanding/ | | | |
| | | Aggregate | No. of | Fully | Fully | Fund Assets | | |
| | | Value | Shares | Diluted) | Diluted) | & Liabilities | Fund GAV | Fund NAV |
| Investment | CS Issued | $100 | 10 | N/A | $10.00/ | | | |
| and | (Before | | | | $10.00 | | | |
| Grant | Grant) | | | | | | | |
| | CO VUS | $20 | 2.5 | $10.00/ | N/A | | | |
| | | | | $8.00 | | | | |
| | CS Issued | $100 | 10 | N/A | $10.00/ | | | |
| | (After | | | | $8.00 | | | |
| | Grant) | | | | | | | |
| | CO SP | $20 | N/A | N/A | N/A | | | |
| | CO Spread | $0 | N/A | N/A | N/A | | | |

| | | | |
|---|---|---|---|
| Assets Beginning of Year (BOY) | $0 | | |
| Contribution (BOY) | $100 | | |
| Total Assets (BOY) | $100 | $100 | |
| Spread Liability/Equity (BOY) | ($0) | | $100 |

TABLE 10

| | | | | GAV per | NAV per | | | |
|---|---|---|---|---|---|---|---|---|
| | | | | Share | Share | | | |
| | | | No. | (Outstanding/ | (Outstanding/ | Fund | | |
| | | Aggregate | of | Fully | Fully | Assets & | | |
| | | Value | Shares | Diluted) | Diluted) | Liabilities | Fund GAV | Fund NAV |
| 100% | CS Issued | $180 | 10 | N/A | $18.00/ | | | |
| Return | | | | | $14.40 | | | |
| End of | CO VUS | $40 | 2.5 | $20.00/ | N/A | | | |
| Year | | | | $16.00 | | | | |
| One | CO SP | $20 | N/A | | N/A | | | |
| | CO | $20 | N/A | | N/A | | | |
| | Spread | | | | | | | |

| | | | |
|---|---|---|---|
| Assets Beginning of Year (BOY) | $100 | | |
| Growth End of Year (EOY) | $100 | | |
| Total Assets (EOY) | $200 | $200 | |
| Spread Liability/Equity (BOY) | ($20) | | $180 |

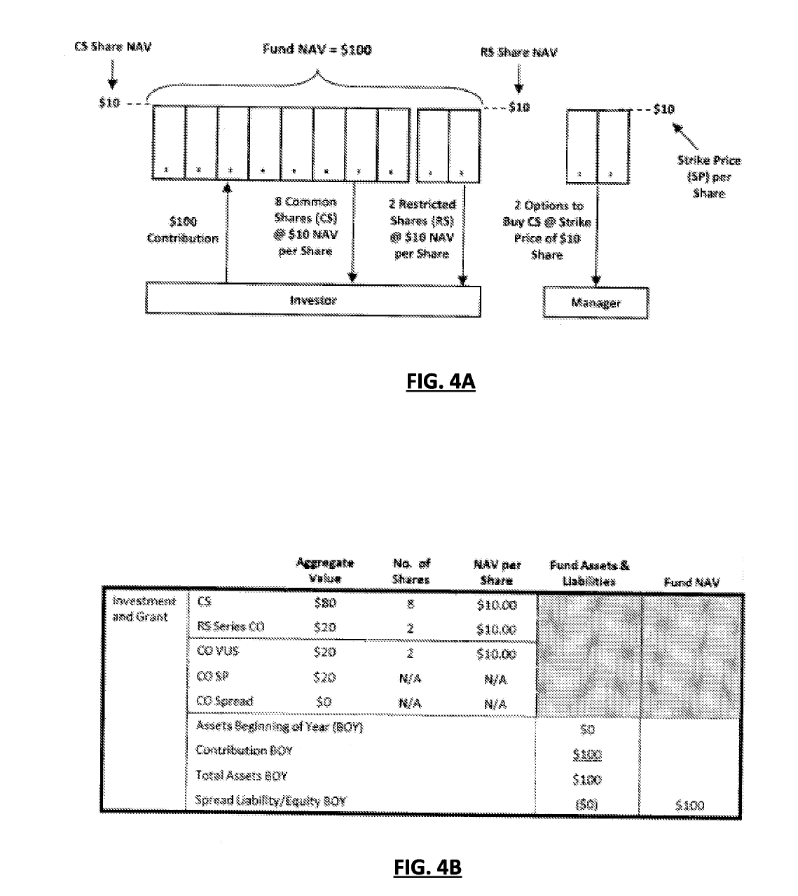

FIGS. 4A to 4B in turn illustrate the capital structure for an investment fund using an embodiment of the fund alignment rights of the present invention. In this example, a manager provides services to a hedge fund and in exchange, the hedge fund agrees to provide incentive compensation to the manager consisting of fund alignment rights (such as FMV options or SARs). Using this exemplary embodiment of the present invention, the grant of the options/SARs does not dilute the common shares because the price, or NAV, of an underlying share is not changed by the grant.

In this example, the fund issues two classes or series of shares to an investor—common shares and restricted shares. The common shares participate fully in profits and losses after expenses, while the restricted shares do not. The price, or net asset value (NAV), of a restricted share is the NAV of the common shares but not greater than the maximum NAV. The maximum NAV is the NAV of the restricted share at date of grant of the FMV option/SAR. Table 11 below shows a $100 investment and a 100% return at the end of the first year.

TABLE 11

| | | | | | | | | FMV Option/SAR | | | | |
|---|---|---|---|---|---|---|---|---|---|---|---|---|
| | | | | | | | | | No. of | | | |
| | | | | No.of | NAV per | No. of | NAV per | | Underlying | | | New |
| | | | Fund | Common | Common | Restricted | Restricted | | Common | Strike | | Investor's |
| Return | | Contribution | NAV | Shares | Share | Shares | Share | VUS | Shares | Price | Spread | Balance |
| | Immediately | | $100.00 | 100.00 | $1.00 | | | | | | | |
| | Before | | | | | | | | | | | |
| | Contribution | | | | | | | | | | | |
| | Contribution | $100.00 | $200.00 | 80.00 | $1.00 | 20.00 | $1.00 | $20.00 | 20.00 | $20.00 | $0.00 | $100.00 |
| | Immediately | | $200.00 | 180.00 | $1.00 | 20.00 | $1.00 | $20.00 | 20.00 | $20.00 | $0.00 | $200.00 |
| | After | | | | | | | | | | | |
| | Contribution | | | | | | | | | | | |
| 100% | End of Year | | $400.00 | 80.00 | $2.00 | 20.00 | $1.00 | $40.00 | 20.00 | $20.00 | $20.00 | $180.00 |
| | One | | | | | | | | | | | |

Table 12 below shows a $100 investment and a −50% return at the end of the first year.

TABLE 12

| | | | | | | | | FMV Option/SAR | | | | |
|---|---|---|---|---|---|---|---|---|---|---|---|---|
| | | | | | | | | | No. of | | | |
| | | | | No.of | NAV per | No. of | NAV per | | Underlying | | | New |
| | | | Fund | Common | Common | Restricted | Restricted | | Common | Strike | | Investor's |
| Return | | Contribution | NAV | Shares | Share | Shares | Share | VUS | Shares | Price | Spread | Balance |
| | Immediately | | $100.00 | 100.00 | $1.00 | | | | | | | |
| | Before | | | | | | | | | | | |
| | Contribution | | | | | | | | | | | |
| | Contribution | $100.00 | $200.00 | 80.00 | $1.00 | 20.00 | $1.00 | $20.00 | 20.00 | $20.00 | $0.00 | $100.00 |
| | Immediately | | $200.00 | 180.00 | $1.00 | 20.00 | $1.00 | $20.00 | 20.00 | $20.00 | $0.00 | $200.00 |
| | After | | | | | | | | | | | |
| | Contribution | | | | | | | | | | | |
| −50% | End of Year | | $100.00 | 80.00 | $0.50 | 20.00 | $0.50 | $10.00 | 20.00 | $20.00 | $0.00 | $60.00 |
| | One | | | | | | | | | | | |

In the illustrated embodiment, there is no dilution of the common shares and thus no drop in the fund NAV. Investor contributes $100 to fund, and fund issues common series shares giving investor full participation in profits and losses after expenses, management fees and incentive compensation, and restricted shares that do not participate in profits but do participate in losses. Common series stock qualifies as Section 305 stock. FIG. 4A illustrates the investment and grant of common and restricted shares, and FIG. 4B is a chart showing the capital structure from the investment and grant. As can be seen in FIG. 4B, the common shares are not diluted.

In addition to issuing options/SARs with respect to contributions, the fund can agree to issue options/SARs periodically with respect to new growth or new profits. Table 13 below illustrates the economics of issuing new growth options/SARs. It uses the same contribution and return assumptions as used in FIGS. 2A-J.

TABLE 13

| | | | FMV Option/SAR (BOY) | | | | FMV Option/SAR (EOY) | | | | | |
|---|---|---|---|---|---|---|---|---|---|---|---|---|
| | | | Value of | | | Investor's | Value of | | | Investor's | | |
| | | Contribu- | Underlying | | | Balance if | Underlying | | | Balance if | Fund | Fund |
| | | tion | Shares | Strike | | Option/SAR | Shares | Strike | | Option/SAR | Assests | Assests |
| Year | Return | (BOY) | (VUS) | Price | Spread | Exercised | (VUS) | Price | Spread | Exercised | (BOY) | (EOY) |
| 1 | 100% | $100 | $20 | $20 | $0 | $100 | $40 | $20 | $20 | $180 | $100 | $200 |
| 2 | 100% | | $40 | $20 | $20 | $180 | $80 | $20 | $60 | $324 | $200 | $400 |
| Yr 1 NGO/SARs | | | $16 | $16 | $0 | | $32 | $16 | $16 | | | |
| 3 | −50% | | $80 | $20 | $60 | $324 | $40 | $20 | $20 | $180 | $400 | $200 |
| Yr 1 NGO/SARs | | | $32 | $16 | $16 | | $16 | $16 | $0 | | | |
| Yr 1 NGO/SARs | | | $29 | $29 | $0 | | $14 | $29 | $0 | | | |
| 4 | 100% | | $40 | $20 | $20 | $160 | $60 | $20 | $60 | $324 | $200 | $400 |
| Yr 1 NGO/SARs | | | $16 | $16 | $0 | | $32 | $16 | $16 | | | |
| Yr 2 NGO/SARs | | | $14 | $29 | $0 | | $23 | $29 | $0 | | | |
| Yr 3 NGO/SARs | | | $0 | $0 | $0 | | $0 | $0 | $0 | | | |
| 5 | 100% | | $80 | $20 | $60 | $324 | $160 | $20 | $140 | $583 | $400 | $800 |
| Yr 1 NGO/SARs | | | $32 | $16 | $16 | | $64 | $16 | $48 | | | |
| Yr 2 NGO/SARs | | | $29 | $29 | $0 | | $68 | $29 | $29 | | | |
| Yr 3 NGO/SARs | | | $0 | $0 | $0 | | $0 | $0 | $0 | | | |
| Yr 4 NGO/SARs | | | $0 | $0 | $0 | | $0 | $0 | $0 | | | |

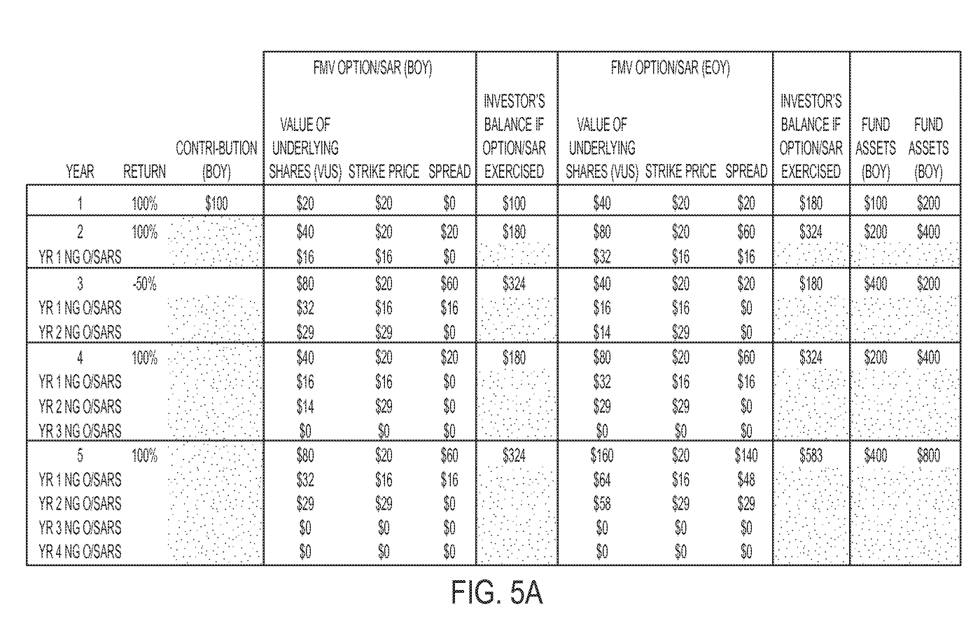

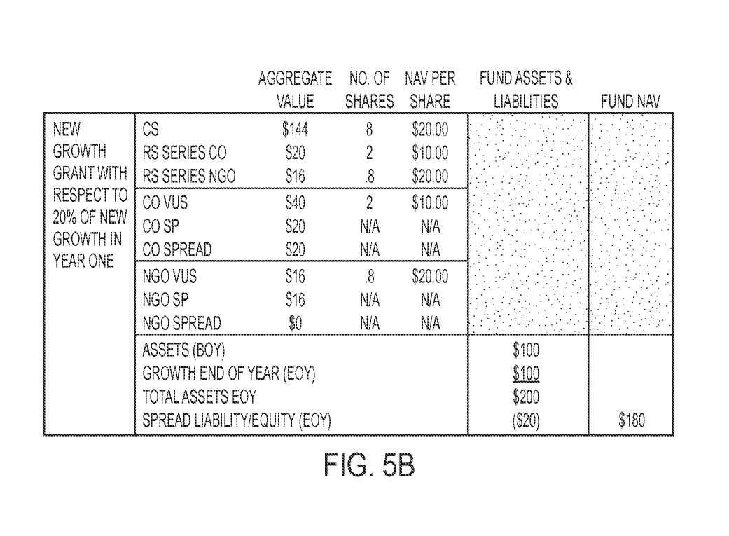

FIGS. 5A-5B are charts that illustrate granting fund alignment rights (e.g., options/SARs) with respect to new profits or new growth according to various embodiments of the present invention. In FIGS. 5A-5B, “NGO” indicates a new growth option/SAR. FIG. 5A shows the capital structure after 100% return at the end of year one, and FIG. 5B shows the capital structure with a new growth option/SAR with respect to 20% of the new growth in year one. Table 14 below shows the capital structure after 100% growth in year two.

TABLE 14

| | | Aggregate | No. of | NAV per | Fund Assets & | |
|---|---|---|---|---|---|---|
| | | Value | Shares | Share | Liabilities | Fund NAV |
| 100% | CS | $288 | 8 | $40.00 | | |
| Return End | RS Series CO | $20 | 2 | $10.00 | | |
| of Year two | RS Series NGO | $16 | .8 | $20.00 | | |
| | CO VUS | $80 | 2 | $10.00 | | |
| | CO SP | $20 | N/A | N/A | | |
| | CO Spread | $60 | N/A | N/A | | |
| | NGO VUS | $32 | .8 | $40.00 | | |
| | NGO SP | $16 | N/A | N/A | | |
| | NGO Spread | $16 | N/A | N/A | | |

| | | |
|---|---|---|
| Assets (BOY) | $200 | |
| Growth End of Year (EOY) | $200 | |
| Total Assets EOY | $400 | |
| Spread Liability/Equity (EOY) | ($76) | $324 |

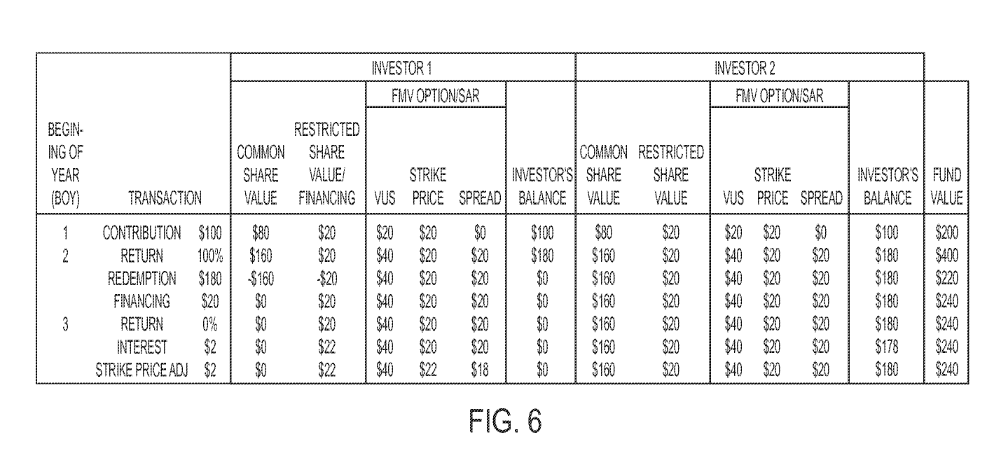

In various implementations of the present invention, when an investor redeems, the fund can continue the orphaned options/SARs without diluting remaining investors by borrowing an amount equal to strike price of orphaned options/SARs and making strike price adjustments (increases) equal to or greater than the interest cost of the borrowing. FIG. 6 is a table illustrating the financing of orphaned options/SARs upon redemption of related shares according to various embodiments of the present invention. The example of FIG. 6 shows two investors, where investor 1 has a $180 redemption at the beginning of year 2 following a 100% return during year one. Thus, the orphaned options/SARs are continued without diluting investor 2 by borrowing an amount equal to the strike price of the orphaned options/SARs and without making strike price adjustments (increases) equal to or greater than the interest cost of the borrowing.

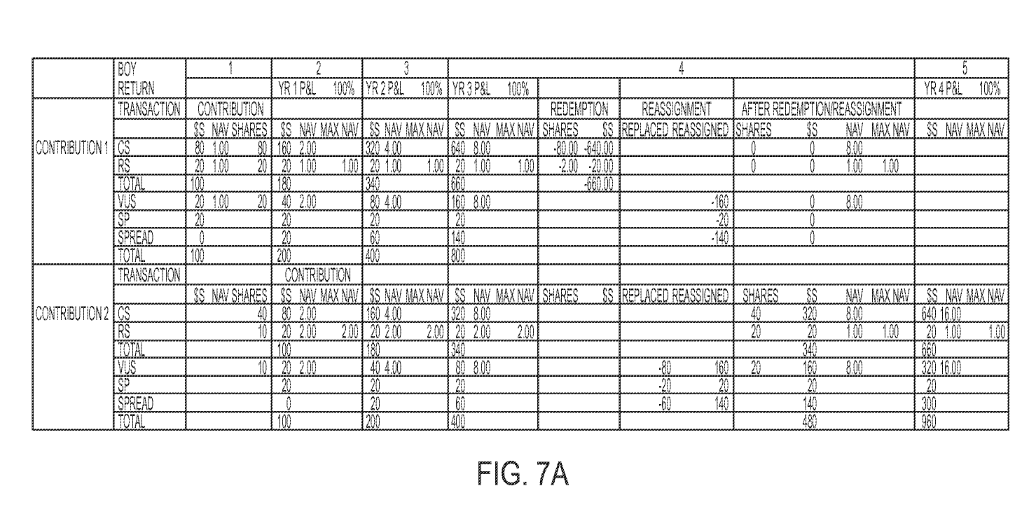

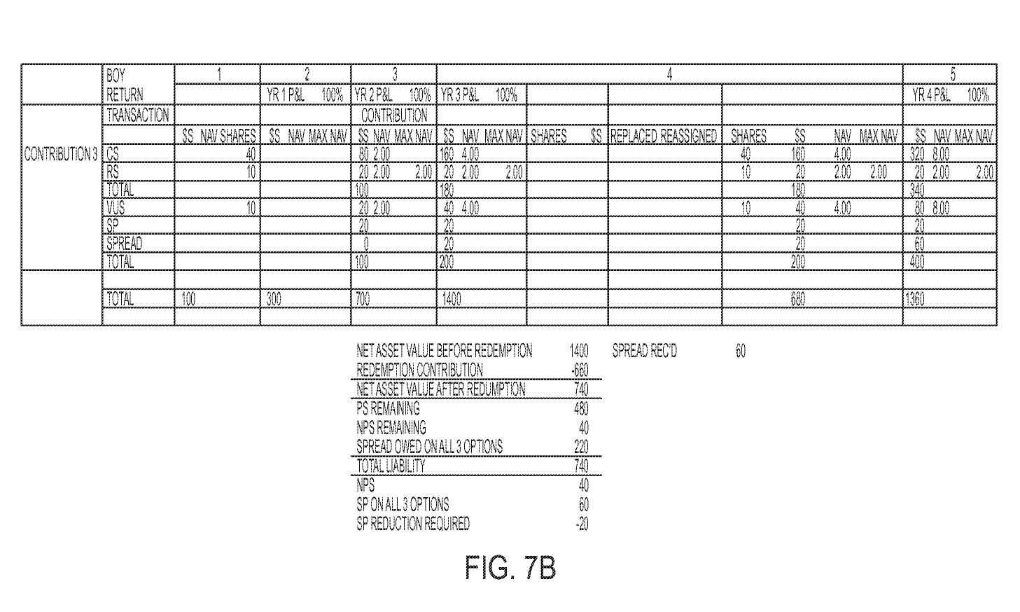

In various implementations of the present invention, when an investor redeems, the fund can reassign orphaned options/SARs to contributions with related options/SARs that are less valuable than the orphaned options/SARs. Options/SARs that are replaced become orphaned options/SARs, and the process continues until the remaining orphaned options/SARs are the least valuable. When an orphaned option/SAR is reassigned, the NAV of the restricted shares related to such options/SARs carry over and apply to the restricted shares that relate to the reassigned option/SAR. If the option/SAR is reassigned to a new contribution, the restricted shares are assigned the maximum NAV that applied to the restricted shares that were redeemed and orphaned the option/SAR. If the option/SAR is reassigned to existing restricted shares, the maximum NAV of such restricted shares is replaced with the maximum NAV of the restricted shares that were redeemed thereby leaving the option/SAR with no related restricted shares. FIGS. 7A and 7B collective comprise a table that illustrate an example of reassigning options/SARs according to a prescribed optimization process according to various embodiments of the present invention.

In addition, managers who are owed deferred compensation that becomes taxable in later years can cap the balance before the end of the year it become taxable and tax-defer the growth for as long they want. For example, assume a manager is owed $1 billion in 2014. If it were to grow 15% a year for the next three years (2015, 2016 and 2017), the balance would be approximately $1.5 billion by the end of 2017. If the manager does nothing, it will pay taxes on not only 2014's $1 billion balance but the $500 million of growth.

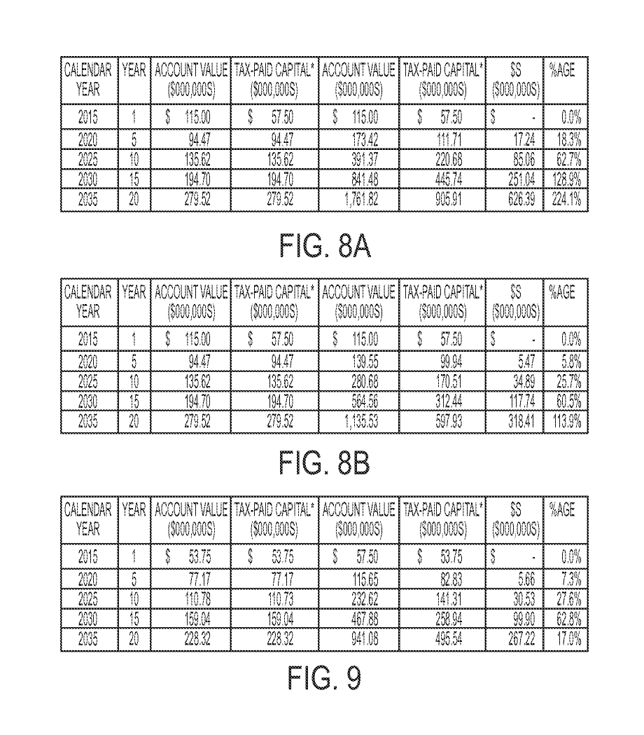

Alternatively, the manager can act now to cap the deferral balance at $1 billion, and receive an option/SAR which delivers all the growth on the $1 billion tax-deferred for as long as the manager wishes. The manager does not pay taxes on the growth until the manager elects to exercise the option/SAR, which could be 10 years, 15 years or 20 years from the date of grant. In 2018, the manager will owe the tax on the $1 billion of deferred compensation, or about $500 million. At a minimum, the fund would make a $500 million distribution to the manager. To maximize wealth accumulation, the fund would keep the full $1 billion option/SAR intact by borrowing $500 million to replace the $500 million of capital distributed for taxes. The interest cost of the borrowing would be charged to the option/SAR—i.e., to the manager. FIG. 8A is a chart showing an example of the Cap, Option, and Borrow (COB) process. As the last column in the chart shows, COB provides an advantage that grows over time in the example scenarios.

Alternatively, instead of borrowing the fund would require the manager to exercise the option/SAR to the extent needed to cover the manager's taxes and leave deferred compensation equal to the option/SAR strike price. So in 2018 when taxes are due, the manager would take about $400 million from the deferred comp balance, and exercise $200 million of the option/SAR spread or profit. That would give the manager cash to pay taxes of $600 million, while maximizing the remaining options/SARs with an underlying value of $0.9 billion, a strike price of $600 million and a spread of $300 million. FIG. 8B is a chart showing an example of the Cap, Option, and Exercise (COE) process. As the last column in the chart shows, COE also provides an advantage that grows over time in the example scenarios

By borrowing, the manager receives all the growth on $1 billion less the interest cost on $500 million. If the fund grows at 15%, and the interest cost is 5%, then after 10 years the manager's capital would be $500 million tax-paid and $2.9 billion of tax-deferred capital (option/SAR spread). If the manager were to liquidate, it would have about $2 billion of tax-paid capital.

If the manager were to exercise to pay the 2018 taxes, after 10 years the manager's capital would be $600 million tax-paid, and $1.9 billion tax-deferred. If the manager were to liquidate, it would have about $1.6 billion of tax-paid capital.

Compare the $2 billion or $1.6 billion to what the manager would have if it were to do nothing, pay taxes in 2018 on the entire $1.5 billion deferred comp balance and reinvest the after-tax amount ($750 million) in the fund. The manager would pay taxes each year on the growth. Assuming a 50% tax rate, the manager would have only $1.3 billion after 10 years.

The advantage of capping the deferred compensation and receiving options/SARs grows exponentially. After 20 years, the tax paid balances would be $7.9 billion, $5.3 billion and $2.6 billion, respectively.

Currently, managers earn incentive compensation (IC) that is taxable each year. Most managers receive their IC as a profits participation (commonly called “carried interest”), and the character of the fund's income (i.e., ordinary, capital gains, dividends, tax-exempt interest) flows through to the manager. Managers' combined marginal tax rates vary widely, from 30% to 55%, depending on manager's investment style and tax jurisdiction. It is common for managers to reinvest their after-tax IC in the fund.

In implementations of the present invention, a manager can increase wealth accumulation substantially, and without tax risk, by reinvesting after-tax IC in restricted shares (“RS”) of the fund, and receiving compensatory FMV options/SARs with an aggregate value of underlying stock (VUS) equal to the RS NAV. The RS participates in losses but not in profits; issue date NAV is maximum NAV. For example, suppose a manager has $100 million of IC and has an effective tax rate of 50%:
The manager would reinvest $50 million in RS;
The fund would grant the manager options/SARs to purchase such number of common shares (CS) that have an aggregate value at date of grant of $50 million;
If the NAV were $100,000 per CS, Manager would have options/SARs to buy 500 shares at a strike price of $100,000 each;
If, for example, NAV were to grow to $200,000, each option/SAR would have VUS/SP of $200,000/$100,000, and a spread (excess of VUS over SP) of $100,000, and the aggregate spread would be $50 million; and
The spread is the manager's profit or benefit. Spread is tax-deferred and not taxable until the manager elects to exercise options/SARs.
   FIG. 9 is a table showing an example of the differences between reinvesting IC with annual taxation and, on the other hand, reinvesting IC for options (RfO). As FIG. 9 shows, the advantage provided with RfO can be significant.

Turning now to a prior art compensation method—the American method—for private equity funds, a manager provides services to a private equity fund and, in exchange, the fund agrees to provide incentive compensation to the manager consisting of a specified percentage of the profits the manager generates for the fund's investors. The fund has a finite life, and invests in a finite number of deals. The fund uses the so-called “American Method” to calculate the manager's incentive compensation. Under this method, the manager receives a specified percentage of the profit made on each deal. Under this method, the manager can receive profits from the fund even though the investor receives no profits or loses money from the fund (i.e., after all deals are done).

Under the American Method private equity model, each Deal realization triggers payment to the investors and the manager. Investors receive their return of capital allocated to the Deal, their hurdle return and their share of profits. The manager receives its share of profits, which may consist of a catch-up share and then its share of profits in excess of the catch-up. Table 15 below illustrates the American Method. It assumes a $100 contribution allocated equally among 5 Deals, an 8% hurdle rate, a catch-up allocation for the manager, and profits divided between the investors and manager 80/20. For purposes of simplicity, the management fee is assumed to be zero.

TABLE 15

| | Deal 1 | Deal 2 | Deal 3 | Deal 4 | Deal 5 |
|---|---|---|---|---|---|
| Year Realized (BOY) | 3 | 4 | 5 | 6 | 7 |
| Cumulative Return | 100% | 100% | −50% | −50% | −50% |
| Preferred Return Hurdle | 3.33 | 5.19 | 7.21 | 9.39 | 11.74 |
| (by Deal) | | | | | |
| Catch Up Allocation | 0.83 | 1.3 | 1.8 | 2.35 | 2.93 |
| Profit (Loss) | 20 | 20 | −10 | −10 | −10 |
| Manager Distributions | 4 | 4 | 0 | 0 | 0 |
| Fund Cumulative P&L | 20 | 40 | 30 | 20 | 10 |
| Cumulative Investor | 36 | 72 | 82 | 92 | 102 |
| Distributions | | | | | |
| Cumulative Manager | 4 | 8 | 8 | 8 | 8 |
| Distributions | | | | | |
| Cumulative Fund | 40 | 80 | 90 | 100 | 110 |
| Distributions | | | | | |
| Investor's Net Cash | | | | | 2 |
| Flow at End of Fund | | | | | |

| | |
|---|---|
| Investor's Loss from Manager Distributions (Amount of | 8 |
| Clawback Owed by Manager) | |

As Table 15 illustrates, under the American Method investors can receive less, and the manager more, than its nominative share of profits. In this example, there were $10 of cumulative profits, all of which the investors should have received as part of the hurdle return. Instead, they received only $2, and need to recover (“claw back”) $8 from the manager.

Another prior art compensation method for private equity funds is the European method. Unlike the American Method where the fund pays the manager its share of the profits when a deal is done, under the European Method the fund pays the manager its share of the cumulative profits at the end of the fund after all deals are done, with one major exception. Because the manager is taxable on its share of the profits when profits are realized (i.e., upon closure of a deal), the fund makes a tax distribution to the manager for each year in which the manager must recognize taxable income. Typically, the fund pays 40% of the profits realized, and recognized as income, by the manager. The remainder of the manager's share of realized profits is held back and paid at the end of the life of the fund, after all deals are done. Upon deal closure and fund closure the fund capital is distributed according to a “waterfall” where investors receive their contributions back first, then realized profits up to the hurdle rate on their capital, the manager receives a “catch up” allocation of profits, then the investors receive their share of the cumulative profits in excess of the hurdle rate, then the remaining realized profits are divided between the investors and the manager in the specified percentages. Although this method creates better alignment than the American Method, it nevertheless poses the risk that the manager will receive distributions in excess of the nominative share of cumulative profits intended. For example, when the parties agree to divide profits 80/20 (80% for the investor and 20% for the manager), the intent is for cumulative, terminal profits to be divided 80/20. But the need to reimburse the manager for tax liability on profitable deals can produce the result where the manager receives more than 20% of the cumulative, terminal profits.

Under the European Method private equity model, each Deal realization triggers a payment to the investors and the manager. Investors receive their return of capital allocated to the Deal, their hurdle return and their share of profits. Unlike under the American Method where the manager receives its share of profits, under the European Method the manager receives a portion of its share of the profits. The partial payment is designed to be no less than the income taxes the manager owes on its share of the profits. The manager's share of profits may consist of a catch-up share and then its share of profits in excess of the catch-up. Table 16 below illustrates an example of the European Method. It assumes a $100 contribution allocated equally among 5 Deals, an 8% hurdle rate, a catch-up allocation for the manager, and profits divided between the investors and manager 80/20. For purposes of simplicity, the management fee is assumed to be zero.

TABLE 16

| | Deal 1 | Deal 2 | Deal 3 | Deal 4 | Deal 5 |
|---|---|---|---|---|---|
| Year Realized (BOY) | 3 | 4 | 5 | 6 | 7 |
| Cumulative Return | 100% | 100% | −50% | −50% | −50% |
| Preferred Return Hurdle | 16.64 | 22.88 | 26.57 | 29.75 | 32.38 |
| Catch Up Allocation | 4.16 | 5.72 | 6.64 | 7.44 | 8.1 |
| Profit (Loss) | 20 | 20 | −10 | −10 | −10 |
| Manager Distributions | 1.34 | 1.86 | 0 | 0 | 0 |
| Fund Cumulative P&L | 20 | 40 | 30 | 20 | 10 |
| Cumulative Investor | 38.66 | 76.8 | 86.8 | 96.8 | 106.8 |
| Distributions | | | | | |
| Cumulative Manager | 1.34 | 3.2 | 3.2 | 3.2 | 3.2 |
| Distributions | | | | | |
| Cumulative Fund | 40 | 80 | 90 | 100 | 110 |
| Distributions | | | | | |
| Investor's Net Cash | | | | | 6.8 |
| Flow at End of Fund | | | | | |

| | |
|---|---|
| Investor's Loss from Manager Distributions (Amount of | 3.2 |
| Clawback Owed by Manager) | |

As Table 16 illustrates, under the European Method investors can receive less, and the manager more, than its nominative share of profits. In this example, there were $10 of cumulative profits all of which the investors should have received as part of the hurdle return. Instead, the investors received only $6.8, and need to recover $3.2 from the manager. Although the European Method reduces the amount of claw back required, as compared to the American Method, it nevertheless poses the risk of overpaying the manager and underpaying investors.

Fund alignment rights according to embodiments of the present invention can overcome the drawbacks of the American and European methods for private equity funds. To illustrate, assume a manager provides services to a private equity fund and, in exchange, the fund agrees to provide incentive compensation to the manager consisting of FMV options/SARs with respect to each contribution or investment made by an investor, and with respect to each deal. The FMV options/SARs are designed to provide a true sharing of cumulative terminal profits with respect to each dollar invested, without the exceptions inherent in the American Method or the European Method.

Table 17 below illustrates the applicant's method for granting FMV options/SARs with respect to each contribution and each deal, and, upon each Deal Realization, adjusting the strike prices of the options/SARs related to the remaining unrealized deals as necessary to ensure that the cumulative profits on each dollar of an investor's investment with the manager are shared as specified. It assumes a $100 contribution allocated equally among 5 Deals, an 8% hurdle rate, a catch-up allocation for the manager, and profits divided between the investors and manager 80/20. For purposes of simplicity, the management fee is assumed to be zero. With respect to each Deal, the fund issues the manager a FMV option/SAR providing 20% of the profits from the Deal, subject to an 8% hurdle rate and a catch-up allocation for the manager. To provide the hurdle return, the strike price is increased at a rate equal to the hurdle return. Upon a Deal Realization, additional adjustments may be made to the strike prices of all the options/SARs issued with respect to the investor's contribution. If the Deal Realization is greater than the hurdle, but not enough to provide full catch up, the strike prices are reduced accordingly (but not below the FMV of the shares at the date of issuance). If the Deal Realization is at a loss, the strike prices are increased accordingly.

TABLE 17

| | Deal 1 | Deal 2 | Deal 3 | Deal 4 | Deal 5 |
|---|---|---|---|---|---|
| Year Realized | 3 | 4 | 5 | 6 | 7 |
| Cumulative Return | 100% | 100% | −50% | −50% | −50% |
| Preferred Return Hurdle | 16.64 | 23.09 | 27.18 | 30.79 | 33.9 |
| Catch Up Allocation | 4.16 | 5.77 | 6.79 | 7.7 | 8.47 |
| Profit (Loss) | 20 | 20 | −10 | −10 | −10 |
| Manager Distributions | 0 | 0 | 0 | 0 | 0 |
| Fund Cumulative P&L | 20 | 40 | 30 | 20 | 10 |
| Cumulative Investor | 36 | 72 | 82 | 92 | 110 |
| Distributions | | | | | |
| Cumulative Manager | 0 | 0 | 0 | 0 | 0 |
| Distributions | | | | | |
| Cumulative Fund | 36 | 72 | 82 | 92 | 110 |
| Distributions | | | | | |
| Investor's Net Cash | | | | | 10 |
| Flow at End of Fund | | | | | |

| | |
|---|---|
| Investor's Loss from Manager Distributions | 0 |

The example of Table 17 illustrates that, under embodiments of the present invention, investors always receive their intended share of profits. In this example, there were $10 of cumulative profits, all of which the investors should receive as part of the hurdle return.

In one embodiment, the strike prices can be adjusted using the following algorithms:

$$Weighted Average NAV \\ X = {\sum }_{t = 1}^{n} \frac{RS ( i ) \_Shares}{Total\_RS \_Shares} \times CS ( i ) \_NAVpU \\ Hurdle Expiration NAV , h = hurdle IRR per annum \\ H = f ( \begin{matrix}Total\_CS \_\$ @ Iss , Total\_RS \_\$ @ Iss , \\ Total\_CS \_\$Dist , Total\_RS \_\$Dist , h\end{matrix} ) \\ Y = \frac{( Total\_CS \_\$ @ Iss + Total\_RS \_\$ @ Iss + H )}{( Total\_CS \_Shares @ Iss + Total\_RS \_Shares @ Iss )} \\ Catch \text{-} up Expiration NAV , \\ c = catch \text{-} up allocation percentage \\ \\ B = \frac{( Total\_CS \_\$ @ Iss + Total\_RS \_\$ @ Iss )}{( Total\_CS \_Shares @ Iss + Total\_RS \_Shares @ Iss )} \\ Z = B + \{ ( Y - B ) \times ( 1 + \frac{c}{1 - c} ) \} \\ Strike Price Adjustments \\ If X < Y \\ \\ SAR ( i ) \_SPpU 2 = max \{ CS ( i ) \_NAVpU @ Iss , CS ( i ) \_NAVpU \} \\ If Y < X < Z \\ P = ( \begin{matrix}Total\_CS \_Shares @ Iss + \\ Total\_RS \_Shares @ Iss\end{matrix} ) \times ( X - Y ) \\ Adjust SAR ( i ) \_SPpU2 subject to the following constraints : \\ i ) P = {\sum }_{i = 1}^{n} max \{ 0 , ( SAR ( i ) VUS - SAR ( i ) SP 2 ) \} \\ ii ) SAR ( i ) SPpU 2 \geq CS ( i ) \_NAVpU @ Iss \\ If X > Z \\ SAR ( i ) \_SPpU 1 = CS ( i ) \_NAVpU @ Iss \\ TP = {\sum }_{i = 1}^{n} max \{ 0 , ( SAR ( i ) \_VUS - SAR ( i ) \_SP1 ) \} \\ L = {\sum }_{i = 1}^{n} max \{ 0 , ( SAR ( i ) \_SP1 - SAR ( i ) \_VUS ) u \} \\ Adjust SA R ( i ) \_ S PpU2 \\ subject to the following constraints : \\ i ) TP - L = {\sum }_{i = 1}^{n} max \{ 0 , ( SAR ( i ) \_VUS - SAR ( i ) \_SP 2 ) \} \\ ii ) SAR ( i ) SPpU 2 \geq CS ( i ) \_NAVpU @ Iss$$

Table 18 below illustrates a prior art incentive compensation method for private long only funds. A manager provides services to a private long only fund and, in exchange, the fund agrees to provide incentive compensation to the manager consisting of 10% of the overperformance relative to the benchmark index. Each year, the benchmark resets. Under the prior art method, the investor pays for relative overperformance annually. The manager can receive a share of profits even though the investor loses money or otherwise does not receive any profits.

TABLE 18

| | | | | | Annual Crystallization | | | |
|---|---|---|---|---|---|---|---|---|
| | | | Over- | | Fund NAV | | | Fund NAV & |
| | | | performance | | & Investor's | | Incentive | Investor's |
| | | | (Under- | Contribution | Balance | Profit | Compensation | Balance |
| Year | Return | Benchmark | performance) | (BOY) | (BOY) | (Loss) | (IC) | (EOY) |
| | | | | | | | 10% | |
| 1 | 100% | 90% | 10% | $100 | $100 | $100 | −$1.00 | $199 |
| 2 | −50% | −60% | 10% | | $199 | −$100 | −$1.00 | $99 |

One the other hand, Table 19 below illustrates an incentive compensation method for a manager of a private long only fund using fund alignment rights according to an embodiment of the present invention. Here, the fund agrees to provide incentive compensation to the manager consisting of FMV options/SARs. Under the applicant's method, the investor always receives its nominative share of cumulative terminal profits on its investment.

TABLE 19

| | | | | | FMV Option/SAR | | | |
|---|---|---|---|---|---|---|---|---|
| | | | Over- | | Fund NAV & | | Incentive | Fund NAV & |
| | | | performance | | Investor's | | Compensation | Investor's |
| | | | (Under- | Contribution | Balance | | (IC) If | Balance |
| Year | Return | Benchmark | performance) | (BOY) | (BOY) | Profit (Loss) | Redemption | (EOY) |
| | | | | | | | 10% | |
| 1 | 100% | 90% | 10% | $100 | $100 | $100 | −$1.00 | $199 |
| 2 | −50% | −60% | 10% | | $199 | −$100 | $0.00 | $100 |

Tables 18 and 19 have the same assumptions regarding fund and benchmark returns. In Table 19, however, the fund NAV and investor's balance at the end of the second year is greater than in the prior art example of Table 18 ($100 vs. $99).

Table 20 below illustrates a prior art incentive compensation method for a closed-end 40 Act fund. Under the prevailing prior art method, a closed-end 40 Act fund pays incentive compensation annually based on a rolling average return over a multi-year period. The incentive compensation is an adjustment to the base management fee. For example, assume a fund with an absolute return target of outperforming the S&P 500 Total Return Index and T-bill returns. Assume also that the base fee is 1.5% of AUM, and the incentive compensation is 5% of the overperformance or underperformance. Assume the fund's return over T-bills is 8%, and the fund's return over the S&P 500 Total Return Index is 5%. The base fee would increase by 0.25% to 1.75% (5% times the overperformance of 5%). By way of further example, assume that the fund described in the preceding paragraph realized a negative 4% return when the T-bill rate was 2% and the S&P 500 Total Return Index was −6%. The underperformance would be 6%, and the base fee would be reduced by 0.30% to 1.20%. Table 20 below illustrates the problem with the current model. An investor investing in year 4 would pay an incentive fee even though the investor received no profits.

TABLE 20

| | | | | | | | Fees | | |
|---|---|---|---|---|---|---|---|---|---|
| | | | | | | | | Performance | |
| | Annual Returns | | | Ruling 3-Yr Average Return | | | Over (Under) | Adjustment | |
| Year | Fund | S&P 500 | T-Bills | Fund | S&P 500 | T-Bills | Performance | to Base Fee | Total Fee |
| | | | | | | | | 10.00% | 1.50% |
| 1 | 15.00% | 10.00% | 3.00% | 15.00% | 10.00% | 3.00% | 5.0% | 0.50% | 2.00% |
| 2 | 15.00% | 10.00% | 3.00% | 15.00% | 10.00% | 3.00% | 5.0% | 0.50% | 2.00% |
| 3 | 15.00% | 10.00% | 3.00% | 15.00% | 10.00% | 3.00% | 5.0% | 0.50% | 2.00% |
| 4 | 0.00% | 0.00% | 3.00% | 10.00% | 6.67% | 3.00% | 3.3% | 9.33% | 1.83% |

Because the performance is calculated based on a rolling 36-month average, the investor can receive less than it would have received had the incentive compensation been calculated using the investor's period of investment.

One the other hand, Table 21 below illustrates an incentive compensation method for a manager of a closed-end 40 Act fund using fund alignment rights according to an embodiment of the present invention. Under this approach, the investor always receives its 95% of the actual overperformance of the investor's investment. Further, the investor does not suffer from, or benefit from, performance during periods in which the investor was not invested.

TABLE 21

| | | | | | Fees | | | | |
|---|---|---|---|---|---|---|---|---|---|
| | | | | | Over | Performance | | | |
| | | Annual Returns | | | (Under) | Adjustment | | Balance | Balance |
| Year | Contribution | Fund | S&P 500 | T-Bills | Performance | to Base Fee | Total Fee | after MF | after PA |
| | | | | | | 10.00% | 1.50% | | |
| 1 | | 15.00% | 10.00% | 3.00% | 5.0% | 0.50% | 2.00% | | |
| 2 | | 15.00% | 10.00% | 3.00% | 5.0% | 0.50% | 2.00% | | |
| 3 | | 15.00% | 10.00% | 3.00% | 5.0% | 0.50% | 2.00% | | |
| 4 | $100 | 0.00% | 0.00% | 3.00% | 0.0% | 0.00% | 1.50% | $98.50 | $98.50 |

The major difference between Tables 20 and 21—and one of the benefits that can be attained with the present invention—is that in Table 20, the overperformance fee in year 4 is 3.3% even though the fund's return in year 4 was 0.0%, whereas in Table 21 the overperformance fee is 0.0%.

If a manager is taxed as a partnership, the manager can assign the fund alignment rights (e.g., options/SARs) to its partners. The assignment can be formal or simply a bookkeeping entry whereby the manager promises to pay specified exercise proceeds to specified partners upon receipt. If so assigned, the partners' options/SARs are not subject to future creditors of the manager (assuming the manager is solvent at time of the assignment). The options/SARs are income tax-deferred at SECA tax-deferred.

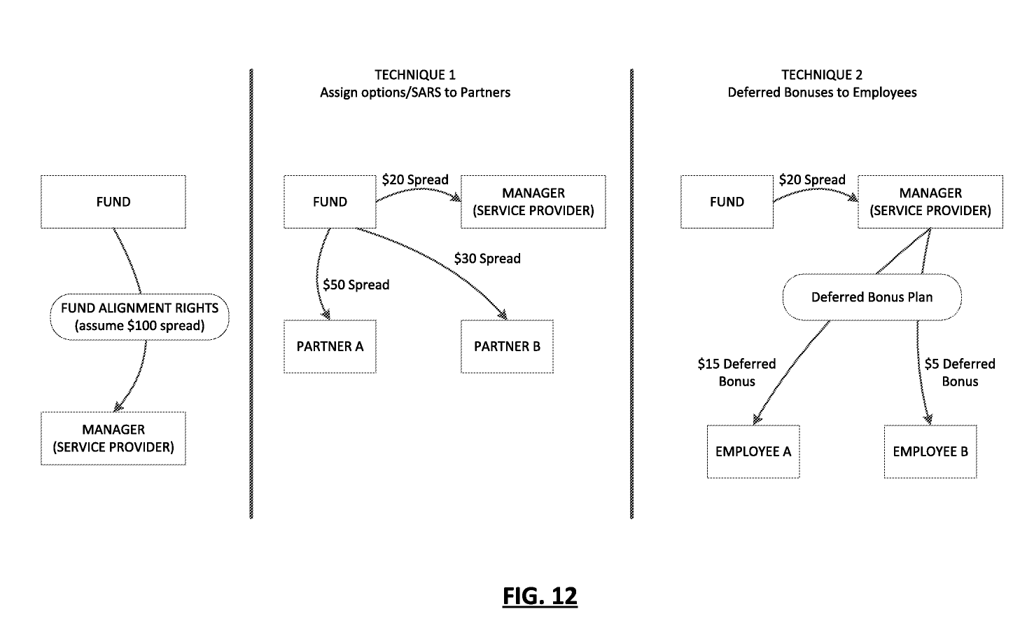

If the service provider is not a partner, the manager must provide the benefits to employees through a nonqualified deferred compensation plan that complies with Code Section 409A. This technique can also be employed by partnership. In such cases, the employees' bonuses can be contingent on future service; partners incur no tax cost; awards to employees are income-tax deferred until received and a FICA wages when vested; the manager can report FICA wages in quarter of vesting or at end of year; and growth of bonuses reported as FICA wages is not subject to FICA. The manager can make awards to partners as well as described in the paragraph above. These two techniques are diagrammed in FIG. 12.

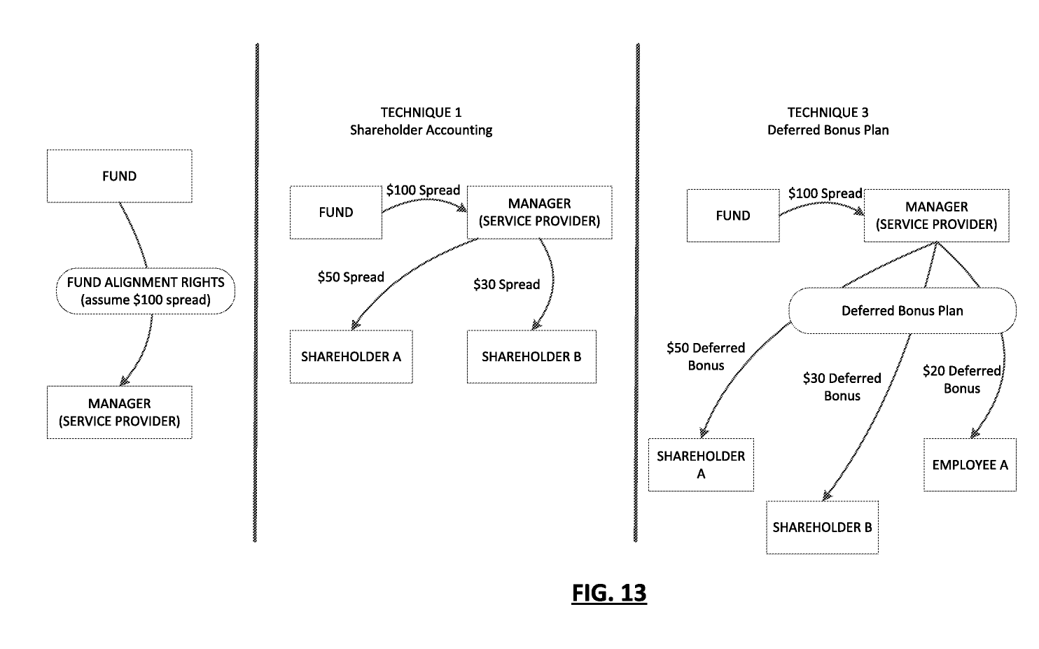

If the manager is taxable as an S corporation or C corporation, the manager can provide the benefits to of the option/SARs issued to it in a number of ways, two of which are illustrated in FIG. 13. If the service provider to the manager is a shareholder, the manager can use either technique shown in FIG. 13. If the service provider is not a shareholder, the manager must use the second technique and provide the benefits through a nonqualified deferred compensation plan that complies with Code Section 409A. In technique one, the manager accounts for each shareholders' interest in the spread. The spread is income tax-deferred and FICA/SECA tax-deferred. When benefits are received, the manager pays the appropriate amounts to the shareholders. The amounts paid are either FICA wages (compensation) or profits distribution (return on capital) that is not subject to FICA. In the second technique, the awards to the shareholder and employees are income-tax deferred until received, and are FICA wages when vested. The manager can report FICA wages in the quarter of vesting, or at the end of the year. Growth of the bonuses after reporting as FICA wages is not subject to FICA (growth escapes FICA taxation).

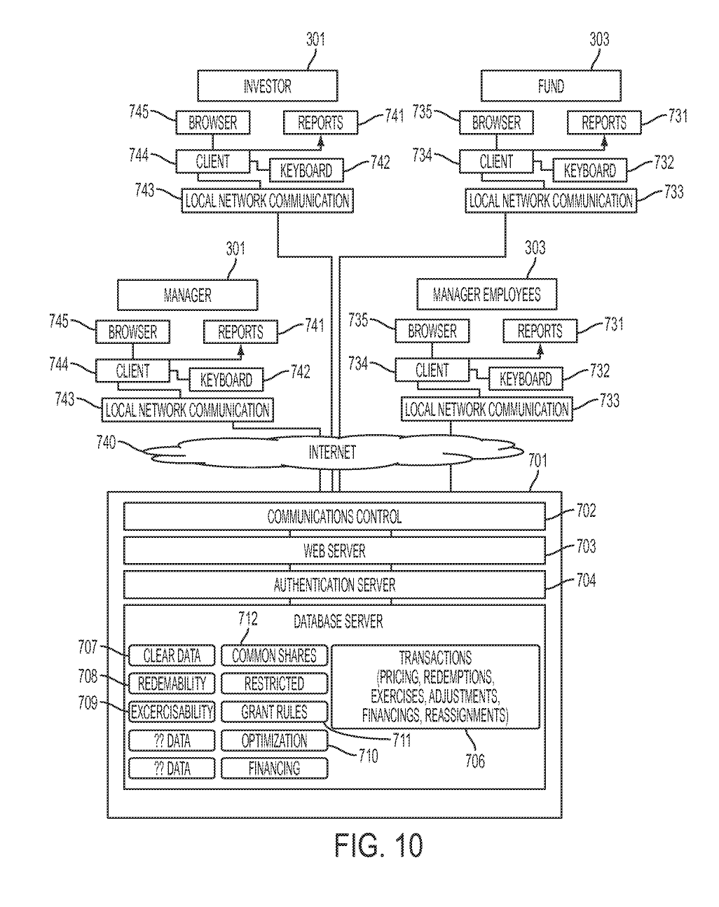

FIG. 10 is a diagram of a computer system according to an embodiment of the present invention, wherein the FMV option/SAR recordkeeping (host) computer system 701 is a web-based administration system that can handle plan design variability and make incentive compensation in the form of FMV options/SARs easy to understand and use by managers, investors and the fund 301. The FMV option/SAR recordkeeping system 701 enables the fund 301 to value, manage and administer, on a daily basis, millions of FMV options/SARs of most any design and their related common shares and restricted shares.

Each option/SAR is treated as the basic design block. Plans can be established with a variety of variable sets of rules regarding strike price, strike price adjustments and strike price adjustment rates, exercisability, early or excessive exercise fees, method of settling options/SARs (i.e., cash or stock), financing orphaned options/SARs, optimizing options/SARs after a redemption, or application of dividends, in the application server 705.

The FMV option/SAR recordkeeping system 701 automates and optimizes the daily processing of contributions, option/SAR grants, common share issuance, restricted share issuance, earliest exercisability dates, exercisability expiration dates, early or excessive exercise fees, earliest redemption dates for related shares, early or excessive redemption fees for related shares, NAVs of common shares, NAVs of restricted shares, dividends, maximum NAV for restricted shares, and reports of option/SAR values (VUS/strike price/spread), share values, deadlines for making exercise and redemption elections, and transactions (contributions, grants, issuance, exercises, redemptions, dividends, financings and reassignments).

The FMV option/SAR recordkeeping system 701 enables the fund 302 to customize incentive compensation plans consisting of FMV options/SARs and provide the fund 302 and managers 301 with safe and reliable administrative support.

The system 702 allows managers 301 and investors 303 to have browser-based or email/online report access to personal positions and aggregate positions (as appropriate) over secure Internet 720 protocols.

Users access the application from a browser over the Internet and access their data through a web application server. Communication through the Internet, between the system, and users, may be handled by a communication control in system, and user local network communication 743, 733. They are authenticated via an Authentication Server 704 to both the Web Server 703 and the Application Server 705. The Application Server contains all of the user data 707, beneficiary data 708, pricing data 709, investment (security) menus 712, payment schedules 711, plan data 710, and all transactions 706 associated with option/SAR activity, to be assessed by users 301, 303. Users 301, 303 can communicate with the system 701 using their client computer 744, 734, and keyboard 742, 732, to communicate directly with their local network communication 743, 733, using their browser 745, 735, and to select and generate reports 741, 731 from the database server 705.

Outbound periodic and occasional reports 741, 731 for values and other information are sent back out from the FMV option/SAR recordkeeping system 701 to the fund, investors and manager. Reports or interfaces directly into fund systems allow for efficient communication among the manager, investors and the fund.

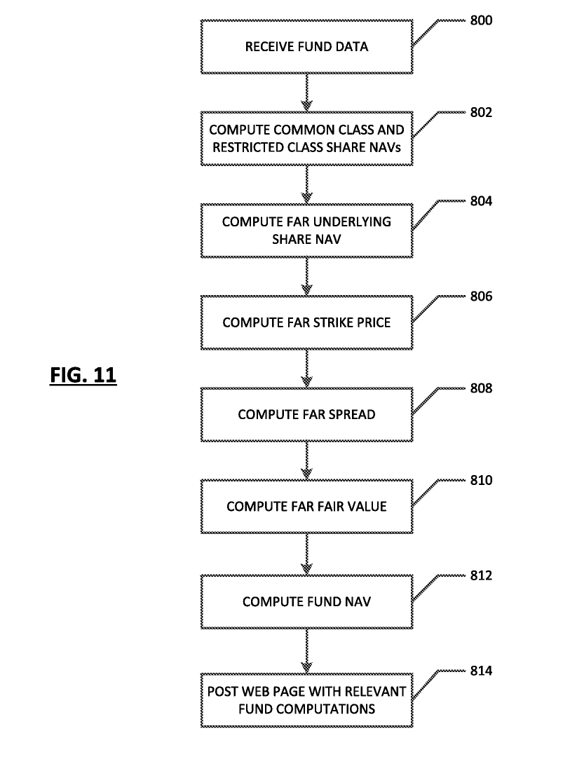

FIG. 11 is a flow chart of a process that may be executed by the host computer system 701 according to various embodiments of the present invention. At step 800, the host computer system 701 receives updated data about the fund from the fund computer system 303. The fund 303 can upload or otherwise transmit the fund data to the host computer system 701 via the Internet or other type of electronic communication network. The data that the fund 303 uploads to the host computer system can include any data necessary for the host computer system 701 to compute, among other things, the common and restricted class share NAVs and the fund alignment right spread and fair value. For examples, the uploaded fund data can include data indicative of the updated fair market value of the fund's property, as well as data indicative of the updated accrued liabilities and expenses of the fund. The fund computer system 303 may upload the data periodically (e.g., nightly following every trading day) and/or from time to time, e.g., following the end of each valuation period. The fund computer system 303 can upload the data in any suitable manner, such as using FTP (File Transfer Protocol), a PHP file upload utility for a data upload website hosted by the web server 703 of the host computer system 701, an email to the host computer system 701, etc.

Once the host computer system 701 has the necessary data, it can compute the relevant fund values described herein. In various embodiments, the application server 705 computes the values following each valuation period and then the web server 703 hosts a webpage with some (or all) of the computed values that authenticated users, such as the users associated with the fund (e.g., the fund manager), can access once authenticated by the authentication server 704. For example, at step 802, the application server 705 can compute the common class and restricted class share NAVs. These NAVs may be computed as follows. The common class share NAV increases (or decreases) in proportion to the fund's gain (or loss) over the valuation period. For example, if the fund's gain over the valuation period was 100%, the common class share NAV increases from $X to $2X (less any applicable expenses, such as management fees etc.). As another example, if the fund lost 50% during the valuation period, the common class share NAV decreases from $X to $0.5X (again, subject any expenses). The restricted class share NAV is the lesser of the common class share NAV and the restricted class maximum NAV (e.g., the restricted class share NAV at issuance, subject to any adjustments).

At step 804, the application server 705 can compute the updated NAV of the underlying shares of the fund alignment rights. In various embodiments, this is equal to the common class share NAV. At step 806, the application server 705 can compute the updated strike price for the fund alignment rights. In various embodiments, the updated strike price is the grater of greater of (i) a minimum strike price and (ii) an indexed strike price. The minimum strike price is preferably the NAV of the underlying (e.g., common class) share NAV at grant. The indexed strike price preferably is the underlying (common class) share NAV at grant times the “strike price-to-NAV ratio,” and increased or decreased from time to time by the applicable “strike price adjustment rate.” The “strike price-to-NAV ratio” is typically 1.0 (or 100%), but could be set to some other value if desired by the fund. The “strike price adjustment rate” is rate of change, if any, to the indexed strike price of the fund alignment rights.

At step 808, the application server 705 computes the spread for the fund alignment rights. The spread is preferably calculated as the excess, if any, of the value of the underlying shares of the fund alignment rights (e.g., the current common class share NAV, computed at step 804) over the current strike price for the fund alignment rights (computed at step 806). At step 810, the application server 705 can then compute the fair value of the fund alignment rights. The fair value can be computed using any suitable option valuation model, such as a type of Black-Scholes option valuation model.

At step 812, the application server 705 can compute other relevant fund parameters and values, including the fund NAV. The fund NAV at any particular time may be the fair market value of all fund property as of such time, less any accrued liabilities and expenses as of such date. For purposes of determining liabilities and expenses, the manager's fund alignment rights spread is the liability and the increase (or decrease) in the fund alignment right spread is the expense (or income). The tables below show example calculations of the common class share and restricted class share NAVs, as well as the fund NAV. Table 21 shows the fund assets at issuance for $100 contribution, where 8 common class shares were issued at $10 each, and 2 restricted class shares were issued at $10. Two fund alignment rights were issued to the manager as incentive compensation with an initial strike price of $10 each, so the corresponding spread at issuance was $0. Thus, the fund net assets were $100 (i.e., the sum of the value of the common class and restricted class shares), and the fund NAV is $10 (the fund net assets divided by the total quantity of issued shares (common and restricted classes)).

TABLE 21
$100 contribution at NAV of $10

| | # of | NAV per | |
|---|---|---|---|
| | shares | share | Value |
| Common shares | 8 | $10 | $80 |
| Restricted shares | 2 | $10 | $20 |
| Subtotal | 10 | | $100 |

| | | | | | Aggregate | | |
|---|---|---|---|---|---|---|---|
| | | | Strike | Spread | Value of | Aggregate | |
| | # | NAV per | price per | per | underlying | strike | Aggregate |
| | of options | option | option | option | securities | price | spread |
| FARs | 2 | $10 | $10 | $0 | $20 | $20 | $0 |
| Total | | | | | | | $100 |

| | |
|---|---|
| # of common shares outstanding | 10 |
| Fund net assets | $100 |
| Fund NAV | $10 |

Table 22 below shows the NAV calculations assuming a 100% over the valuation period. The common class share NAV increased from $10 to $20, making their aggregate value $160 (since 8 common class shares were issued). The value of the restricted class shares stays at $20 (since they do not participate in fund profits), making the cumulative value of the common and restricted class shares $180. The fund alignment rights spread is $10 per option, or $20 total, thereby making the fund gross assets $200. The fund NAV in this example is $18, computed as $180 (the cumulative value of the common and restricted class shares) divided by 10 (the total quantity of common and restricted class shares.

TABLE 22
After 100% return

| | # of | NAV per | |
|---|---|---|---|
| | shares | share | Value |
| Comman shares | 8 | $20 | $160 |
| Restricted shares | 2 | $10 | $20 |
| Subtotal | 10 | | $180 |

| | | | | | Aggregate | | |
|---|---|---|---|---|---|---|---|
| | | | Strike | Spread | Value of | Aggregate | |
| | # | NAV per | price per | per | underlying | strike | Aggregate |
| | of options | option | option | option | securities | price | spread |
| FARs | 2 | $20 | $10 | $10 | $40 | $20 | $20 |
| Total | | | | | | | $200 |

| | |
|---|---|
| # of common shares outstanding | 10 |
| Fund net assets | $180 |
| Fund NAV | $18 |
| Fund gross assets | $200 |
| Fund GAV | $20 |

At step 814, the web server 703 can host a webpage accessible by users associated with the fund via the Internet (or other electronic communication network), once authenticated by the authentication server 704, that posts these updated values, including the updated common and restricted class share NAVs, the updated fund alignment rights spread, and the updated fund alignment rights fair value. In addition, the web site could post the fund alignment rights updated strike price, minimum strike price, and indexed strike price, among other things.

It will be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to embodiments, it is to be understood that this disclosure is only illustrative and exemplary of the present invention and is made merely for purposes of providing a full and enabling disclosure of the invention. This disclosure is not intended or to be construed to limit the present invention or otherwise to exclude any such other embodiments, adaptations, variations, modifications and equivalent arrangements.

In an embodiment, a method may be executed by a computer system 701, to manage a FMV option/SAR incentive compensation arrangement, among a manager 301, an investor 302, and a fund 303, the method comprising the steps of: (a) receiving, by the computer, data about the incentive compensation arrangement from the manager, investor and fund, (b) keeping, by the computer, the accounts for the compensation arrangement, (c) generating, by the computer, reports of the accounts of the compensation arrangement, (d) transmitting, by the computer, the reports to the manager, investor, and fund, (e) permitting authorized access, by the computer, to the data to the manager, investor, and fund, and (f) wherein, the manager is a service provider to the fund directly and to the investor indirectly, and the FMV options/SARs are for the services provided.

The method may further comprise: (a) causing, by the computer, the electronic payment of funds or shares to the manager pursuant to an exercise of options/SARs, (b) causing, by the computer, the electronic payment of funds to the investor pursuant to a redemption of shares, (c) causing, by the computer, the electronic notification to the manager of an investor's election to redeem shares, (d) causing, by the computer, the electronic notification to investors of the manager's election to exercise options/SARs, and (e) causing, by the computer the calculation and reporting of the excess of the investor's return over the return the investor would have realized had the incentive compensation to the manager consisted of Annual Crystallization payments.

Furthermore, the computer may further comprise: (a) a communication control; (b) a web server; configured to transmit and receive data regarding the compensation arrangement, over the Internet, to and from the manager, investor, and fund (or fund's agent such as the fund administrator); (c) an authentication server; and (d) a database server, configured to process user data, beneficiary data, pricing data, compensation arrangement plan data, and transactions, wherein the transactions may include contributions, issuance of common and restricted shares, grants of options/SARs, strike price adjustments, pricing of shares including underlying shares, exercises, redemptions, application of dividends to underlying shares, reassignment of options/SARs, financing of options/SARs, and adjustments.

The method may further comprise: (a) keeping track, by the computer, of the VUS, strike price and spread of options/SARs and the terms related to exercisability and any fees payable to the fund or investors upon exercise; (b) keeping track, by the computer, of the NAVs of common shares and restricted shares and the terms related to the redeemability of shares and any fees payable to the manager or the fund upon redemption, (c) enabling, by the computer, the manager to exercise exercisable options/SARs; (d) enabling, by the computer, investors to redeem redeemable shares; and (e) enabling, by the computer, the manager to redeem shares received in settlement of the exercise of options/SARs.

Furthermore, the FMV option/SAR incentive compensation arrangement may require the granting of new growth FMV options/SARs at specified intervals.

### Other Matters

The present invention requires data and calculations that practically speaking should be maintained and executed on a computer or computer system. Any appropriate computer hardware and software platform may be used, and the present invention is not limited to the hardware or software platform and components of any particular vendor, unless specified otherwise herein.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless or wireline varieties thereof, or any other computerized device capable of configuration for receiving, storing or processing data for standalone application or over a networked medium or media.

Computers and computer systems described herein may include operatively associated non-transitory computer-readable memory media such as memory for storing software applications used in obtaining, processing, storing or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, DVD compact disc, memory stick, ROM (read only memory), RAM (random access memory), PROM (programmable ROM), EEPROM (extended erasable PROM), or other like computer-readable media.

In general, non-transitory computer-readable memory media may include any medium capable of storage of an electronic signal representative of data stored, communicated or processed in accordance with embodiments of the present invention. Where applicable, method steps described herein may be embodied or executed as instructions stored on a non-transitory computer-readable memory medium or media.

It is to be understood that the figures and descriptions of embodiments of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as constriction drawings. Omitted details and modifications or alternative embodiments are within the purview of persons of ordinary skill in the art.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

The examples presented herein are intended to illustrate potential and specific implementations of the present invention. It can be appreciated that the examples are intended primarily for purposes of illustration of the invention for those skilled in the art. The diagrams depicted herein are provided by way of example. There may be variations to these diagrams or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, or parts may be made within the principle and scope of the invention without departing from the invention as described in the following claims.

Various components of embodiments of the invention may be implemented as software code to be executed by a processor of any computer system using any type of suitable computer instruction type. The software code may be stored as a series of instructions or commands on a non-transitory computer readable memory medium. The term “non-transitory computer-readable memory medium” as used herein may include, for example, magnetic and optical memory devices such as diskettes, compact discs of both read-only and writeable varieties, optical disk drives, and hard disk drives. A non-transitory computer-readable memory medium may also include memory storage that can be physical, virtual, permanent, temporary, semi-permanent or semi-temporary.

The methods may be implemented by any suitable type of hardware (e.g., device, computer, computer system, equipment, component), software (e.g., program, application, instruction set, code), storage medium (e.g., disk, device), propagated signal, or combination thereof.

Embodiments of the invention may be implemented utilizing any suitable computer languages (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. These software applications, or computer programs may be stored on a computer readable medium (e.g., disk, device), such that when a computer reads the medium, the functions described herein are performed.

In general, elements of embodiments may be connected through a network having wired or wireless data pathways. The network may include any type of delivery system including, but not limited to a local area network (e.g., Ethernet), a wide area network (e.g., the Internet and/or World Wide Web), a telephone network (e.g., analog, digital, wired, wireless, PSTN, ISDN, and/or xDSL), a packet-switched network, a radio network, a television network, a cable network, a satellite network, and/or any other wired or wireless communications network configured to carry data. The network may include elements, such as, for example, intermediate nodes, proxy services, routers, switches and adapters configured to direct or deliver data.

In general, elements of embodiments may include hardware or software components for communicating with the network and with each other. These elements may be structured and arranged to communicate through the network using various communication protocols (e.g., HTTP, TCP/IP, UDP, WAP, WiFi Bluetooth) or to operate within or in concert with one or more other communications systems.

Elements of embodiments may include one or more servers (e.g. IBM® operating system servers, Linux operating system-based servers, Windows NT™ servers, Sybase) within the system.

A number of implementations of the present invention of the present invention have been described herein. Nevertheless, it will be understood that various modifications may be made and that other implementations are within the scope of the following claims.

Embodiments of the present invention are described hereinafter with reference to the accompanying drawings. Embodiments may be in many different forms and should not be construed as limited to the embodiments set forth herein. Rather, the embodiments are provided as examples of the invention to those skilled in the art. It will be understood that all alternatives, modifications, and equivalents are intended to be included within the spirit and scope of the invention as defined by the appended claims.

What is claimed is:

1. A method comprising:
receiving, via an electronic data communications network, by a host computer system from an investment fund computer system, following a close of a valuation time period, fund growth data indicative of fund growth over the valuation time period by an investment fund associated with the investment fund computer system, wherein:
the investment fund is an eligible issuer of service recipient stock;
prior to the close of the valuation time period, the investment fund issued shares of service recipient stock comprising common class shares and restricted class shares separately to investors in the investment fund, wherein each investor makes a contribution of a contribution amount to the investment fund;
the common class shares participate fully in profits and losses, after expenses, of the investment fund;
the restricted class shares do not participate in profits and losses, after expenses, of the investment fund; and
at issuance of the common and restricted class shares to each investor, the value of the common and restricted class shares collectively equals the contribution amount for that investor;
computing, by an application server of the host computer system, a share Net Asset Value (NAV) of for the common class shares and the restricted class shares issued by the investment fund to the investors, wherein:
the host computer system comprises a data store that stores data indicative of the number of common class shares and restricted class shares issued by the investment fund to the investors;
the share NAV of the common class shares is computed based on the fund growth data; and
the share NAV of the restricted class shares is computed as the lesser of (a) the share NAV of the common class shares and (b) a maximum restricted class NAV;
computing, by the application server of the host computer system, a spread for fund alignment rights issued to a manager of the investment fund as incentive compensation for managing the investment fund, wherein:
the manager is issued fund alignment rights that equal in number the number of restricted class shares issued by the investment fund to the investors;
the fund alignment rights have an underlying stock that is a share of the common class shares, such that compensation payable to the manager upon exercise of a fund alignment right is not greater than an excess of a fair market value of a share of the common class shares on the date of exercise of the fund alignment right over a fair market value of a share of the common class shares on the date the fund alignment right was issued to the manager;
each fund alignment rights has an adjustable strike price that is not less than the fair market value of a share of the common class share on the date the fund alignment right was issued to the manager;
computing the spread per fund alignment right comprises computing a difference between the share NAV of the common class shares and a current value of the adjustable strike price for the fund alignment rights; and
the data store stores data indicative of the current value of the adjustable strike prices for the fund alignment rights;
authenticating, by an authentication server of the host computer system, user access to the host computer system; and
hosting, by a web server of the host computer system, a website accessible via the electronic data communications network by an authenticated user of the investment fund computer system, authenticated by the authentication server, wherein the website posts the share NAV of the common class shares and the spread per fund alignment right for each fund alignment right issued to the manager of the investment fund as incentive compensation.

2. The method of claim 1, wherein the maximum restricted class NAV is the NAV of the restricted class shares at a date of issuance of the restricted class shares.

3. The method of claim 1:
further comprising computing, by the application server, a fair value for each fund alignment rights using an option valuation model; and
wherein hosting the website further comprises posting the fund alignment right fair values on the website.

4. The method of claim 1:
further comprising updating by the application server the adjustable strike prices for the fund alignment rights upon an investor in the investment fund redeeming one or more common class shares; and
wherein computing the spread for a fund alignment right comprises using the updated, adjustable strike.

5. The method of claim 1, wherein the fund alignment rights comprise fair market value options with respect to the common class shares.

6. The method of claim 1, wherein the fund alignment rights comprise fair market value stock appreciation rights with respect to the common class shares.

7. The method of claim 1, wherein the investment fund comprises an investment fund selected from the group consisting of a hedge fund, a private equity fund, a private long only fund, and a closed-end 40 Act fund.

8. The method of claim 1, wherein:
the investment fund is a private equity fund having a plurality of private equity deals managed by the manager, each of the plurality of private equity deals having a hurdle rate;
the investment fund issues the manager a fund alignment right for each of the plurality of private equity deals; and
an initial adjustable strike price for the fund alignment rights is the FMV of the underlying shares at grant of the fund alignment rights plus the hurdle rate for the associated private equity deal.

9. The method of claim 8, further comprising computing by the application server an adjustment for the adjustable strike prices for the fund alignment rights following realization of one of the private equity deals.

10. The method of claim 9, wherein computing an adjustment for the adjustable strike prices comprises reducing a current value of the adjustable strike price upon the deal realization being greater than the hurdle rate for the deal.

11. The method of claim 9, wherein computing an adjustment for the adjustable strike prices comprises increasing a current value of the adjustable strike price upon the deal realization being a loss.

12. A computer system comprising:
an investment fund computer system;
a host computer system in communication with the investment fund computer system via an electronic data communications network, wherein the host computer system comprises:
a web server;
an authentication server; and
an application server,
wherein the application server is for:
receiving, via an electronic data communications network, from the investment fund computer system, fund growth data indicative of fund growth over a time period by an investment fund associated with the investment fund computer system, wherein;
the investment fund is an eligible issuer of service recipient stock;
prior to the close of the valuation time period, the investment fund issued shares of service recipient stock comprising common class shares and restricted class shares separately to investors in the investment fund, wherein each investor makes a contribution of a contribution amount to the investment fund;
the common class shares participate fully in profits and losses, after expenses, of the investment fund;
the restricted class shares do not participate in profits and losses, after expenses, of the investment fund; and
at issuance of the common and restricted class shares to each investor, the value of the common and restricted class shares collectively equals the contribution amount for that investor;
computing a Net Asset Value (NAV) of a share of the common class shares issued by the investment fund, wherein:
the host computer system comprises a data store that stores data indicative of the number of common class shares and restricted class shares issued by the investment fund;
the NAV of a share of the common class shares is computed based on the fund growth data; and
the NAV of a share of the restricted class shares is computed as the lesser of (a) the NAV of a share of the common class shares and (b) a maximum restricted class NAV;
computing a spread for fund alignments right issued to a manager of the investment fund as incentive compensation for managing the investment fund, wherein:
the manager is issued fund alignment rights that equal in number the number of restricted class shares issued by the investment fund to the investors;
the fund alignment rights have any underlying stock that is a share of common class shares, such that compensation payable to the manager upon exercise of a fund alignment right is not greater than an excess of a fair market value of a common class share on the date of exercise over a fair market value of a share of the common class shares on the date the fund alignment right was issued to the manager;
each fund alignment rights has an adjustable strike price that is not less than the fair market value of a share of the common class shares on the date the fund alignment right was issued to the manager;
computing the spread per fund alignment right comprises computing a difference between the NAV of a share of the common class shares and a current value of the adjustable strike price for the fund alignment rights;
the data store stores data indicative of the current value of the adjustable strike price for the fund alignment rights;
wherein the authentication server is for authenticating user access to the host computer system; and
wherein the web server is for hosting a website accessible via the electronic data communications network by an authenticated user of the investment fund computer system, authenticated by the authentication server, wherein the website posts the NAV of a share of the common class shares and the spread per fund alignment right for each fund alignment right issued to the manager of the investment fund as incentive compensation.

13. The computer system of claim 12, wherein the maximum restricted class NAV is the NAV of the restricted class shares at a date of issuance of the restricted class shares.

14. The computer system of claim 12, wherein:
the application server is further for computing a fair value for each fund alignment rights using an option valuation model; and
the website hosted by the web server further comprises posting the fund alignment right fair values on the website.

15. The computer system of claim 12, wherein the application server further computes the adjustable strike prices for the fund alignment rights upon an investor in the investment fund redeeming one or more common class shares, and uses the updated, adjustable strike price to compute the spread for a fund alignment right.

16. The computer system of claim 12, wherein the fund alignment rights comprise fair market value options with respect to the common class shares.

17. The computer system of claim 12, wherein the fund alignment rights comprise fair market value stock appreciation rights with respect to the common class shares.

18. The computer system of claim 12, wherein the investment fund comprises an investment fund selected from the group consisting of a hedge fund, a private equity fund, a private long only fund, and a closed-end 40 Act fund.

19. The computer system of claim 12, wherein:
the investment fund is a private equity fund having a plurality of private equity deals managed by the manager, each of the plurality of private equity deals having a hurdle rate;
the investment fund issues the manager a fund alignment right for each of the plurality of private equity deals; and
an initial adjustable strike price for the fund alignment rights is the FMV of the underlying shares at grant of the fund alignment rights plus the hurdle rate for the associated private equity deal.

20. The computer system of claim 19, wherein the application server further is for computing an adjustment for the adjustable strike prices for the fund alignment rights following realization of one of the private equity deals.

21. The computer system of claim 20, wherein the application server computes an adjustment for the adjustable strike prices by reducing a current value of the adjustable strike price upon the deal realization being greater than the hurdle rate for the deal.

22. The computer system of claim 20, wherein the application server computes an adjustment for the adjustable strike prices by increasing a current value of the adjustable strike price upon the deal realization being a loss.
